(19) United States
(12) Patent Application Publication
(10) Pub. No.: US 2011/0157196 A1
(43) Pub. Date: Jun. 30, 2011

(54) REMOTE GAMING FEATURES

(75) Inventors: Itay Nave, Kfar Hess (IL); Haggai David, Petach-Tikva (IL)

(73) Assignee: EXENT TECHNOLOGIES, LTD., Petach-Tikva (IL)

(21) Appl. No.: 13/021,631

(22) Filed: Feb. 4, 2011

Related U.S. Application Data
(63) Continuation-in-part of application No. 12/878,848, filed on Sep. 9, 2010.
Application No. 12/878,848 is a continuation of application No. 11/204,363, filed on Aug. 16, 2005, now Pat. No. 7,844,442.
(60) Provisional application No. 61/301,879, filed on Feb. 5, 2010.

(51) Int. Cl. G06T 1/00

(52) U.S. Cl. 345/522

(57) ABSTRACT

Features are described herein that may be used to implement a system that enables a user to execute, operate and interact with a software application, such as a video game, on a client wherein the software application is executing on a remote server. The features enable the system to be implemented in an optimized fashion. For example, one feature entails intercepting graphics commands generated by the software application that are directed to a graphics application programming interface (API), manipulating the intercepted graphics commands to produce manipulated graphics commands that are reduced in size as compared to the intercepted graphics commands, and transferring the manipulated graphics commands from the server to the client for rendering thereon.

### CROSS-REFERENCE TO RELATED APPLICATIONS

This application claims priority to U.S. Provisional Patent Application No. 61/301,879, filed Feb. 5, 2010, the entirety of which is incorporated by reference herein. This application is also a continuation-in-part of U.S. patent application Ser. No. 12/878,848, filed Sep. 9, 2010 (still pending), which is a continuation of U.S. patent application Ser. No. 11/204,363, filed Aug. 16, 2005 (now U.S. Pat. No. 7,844,442). The entirety of each of these U.S. patent applications is also incorporated by reference herein.

### BACKGROUND OF THE INVENTION

1. Field of the Invention

The present invention generally relates to user interfaces for an application executing on a computing device. In particular, the present invention relates to a system and method for providing a remote user interface for an application, such as a video game, executing on a computing device.

2. Background

Currently, the platforms available for playing video games or other real-time software applications in the home include personal computers (PC) and various proprietary console-based systems, such as Microsoft's Xbox® and Sony's Playstation®. These platforms are limited in various respects. For example, a given PC can run only a single video game at a time, since the video game requires exclusive control over both the graphics and audio hardware of the PC as well as the PC's display and sound system. This is true regardless of whether the game is being played on-line (i.e., in connection with a server or other PC over a data communication network) or off-line. To enable multiple end users to play different video games at the same time, an entirely new PC or other gaming platform must be purchased and located elsewhere in the home. Furthermore, the end user is confined to playing the video game in the room in which the PC is located.

### SUMMARY

Various features are described herein that may be used to implement a system that enables a user to execute, operate and interact with a software application, such as a video game, on a client (also referred to herein as an end user device) wherein the software application is executing on a remote server. The features enable the system to be implemented in an optimized fashion.

For example, a method for transferring graphics commands generated by a software application executing on a first computer to a second computer for rendering thereon is described herein, wherein the graphics commands are directed to a graphics application programming interface (API). In accordance with the method, the graphics commands are intercepted by a software module executing on the first computer other than the graphics API. The intercepted graphics commands are manipulated to produce manipulated graphics commands that are reduced in size as compared to the intercepted graphics commands. The manipulated graphics commands are then transferred to the second computer for rendering thereon. The second computer may extract renderable graphics commands from the manipulated graphics commands and render the renderable graphics commands.

Depending upon the implementation, manipulating the intercepted graphics commands may include performing one or more of: compressing vertex buffer data associated with at least one intercepted graphics command, compressing at least one matrix associated with at least one intercepted graphics command, identifying and compressing repeated sequences of intercepted graphics commands, compressing at least one texture object associated with at least one graphics command, identifying and removing data associated with one or more of the intercepted graphics commands that is used to represent particles, identifying and removing intercepted graphics commands used to render objects that are less than a predetermined size, and replacing vertex changes associated with at least one intercepted graphics command with a matrix representative thereof. The method may also include one or more additional steps including but not limited to emulating rendering of one of the intercepted graphics command on the first computer by generating a result corresponding thereto and returning the result to the software application and caching one or more graphics objects associated with one or more of the intercepted graphics commands on the second computer.

A computer program product comprising a computer-readable storage medium having computer program logic recorded thereon is also described herein. The computer program logic is for enabling a processing unit to transfer graphics commands generated by a software application executing on a first computer to a second computer for rendering thereon, wherein the graphics commands are directed to a graphics application programming interface (API). The computer program logic includes first means, second means and third means. The first means, which comprise a software module other than the graphics API, are for enabling the processing unit to intercept the graphics commands. The second means are for enabling the processing unit to manipulate the intercepted graphics commands to produce manipulated graphics commands that are reduced in size as compared to the intercepted graphics commands. The third means are for enabling the processing unit to transfer the manipulated graphics commands to the second computer for rendering thereon.

A system is also described herein that includes a first processor-based system and a second processor-based system. The first processor-based system is configured to execute a first software module that intercepts graphics commands generated by a software application also executing on the first processor-based computer system and directed to a graphics application programming interface (API), manipulates the intercepted graphics commands to produce manipulated graphics commands that are reduced in size as compared to the intercepted graphics commands, and transfers the manipulated graphics commands over a network. The second processor-based system is configured to execute a second software module that receives the manipulated graphics commands over the network, extracts renderable graphics commands from the manipulated graphics commands, and renders the renderable graphics commands.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of a system that provides a remote user interface for a software application, such as a video game, executing on a computing device in accordance with an embodiment.

FIG. 2 is a block diagram of an example system that provides remote gaming features in accordance with an embodiment.

FIGS. 3-5 depict flowcharts of methods for preserving user-modified data in accordance with various embodiments of the invention.

FIG. 6 depicts a flowchart of a method for performing compression of vertex buffers in accordance with an embodiment of the present invention.

FIG. 7 depicts a flowchart of a method for performing compression of a 3D command stream in accordance with an embodiment of the present invention.

FIGS. 8 and 9 depict flowcharts of associated methods for emulating commands on a server in a client-server system in accordance with an embodiment of the present invention.

FIGS. 10 and 11 depict flowcharts of associated methods for performing graphics state management of objects on a server in accordance with an embodiment of the present invention.

FIG. 12 depicts a flowchart of one method for converting vertex changes to matrices and transferring such matrices to a client in accordance with an embodiment of the present invention.

FIG. 13 is a block diagram of an example system that utilizes a home PC as a server in accordance with an embodiment of the present invention.

FIG. 14 depicts a flowchart of a method for operating a system that utilizes a home PC as a server in accordance with an embodiment of the present invention.

FIG. 15 depicts a flowchart of a first method for rendering a cursor on a client side of a client-server system in accordance with an embodiment of the present invention.

FIG. 16 depicts a flowchart of a second method for rendering a cursor on a client side of a client-server system in accordance with an embodiment of the present invention.

FIG. 17 depicts a flowchart of a method for transferring graphics commands generated by a software application executing on a first computer to a second computer for rendering thereon in accordance with an embodiment of the present invention.

FIG. 18 is a block diagram of a computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

A. Example Operating Environment

Features associated with a system that provides a remote user interface for an application, such as a video game, executing on a computing device are described herein. The features described herein may be used in conjunction with systems such as those described in commonly-owned, co-pending U.S. patent application Ser. No. 11/204,363 entitled “System and Method for Providing a Remote User Interface for an Application Executing on a Computing Device,” which was filed on Aug. 16, 2005 (now U.S. Pat. No. 7,844,442, issued Nov. 30, 2010). The entirety of U.S. patent application Ser. No. 11/204,363 is incorporated by reference herein. However, the features described herein may be used with other systems as well.

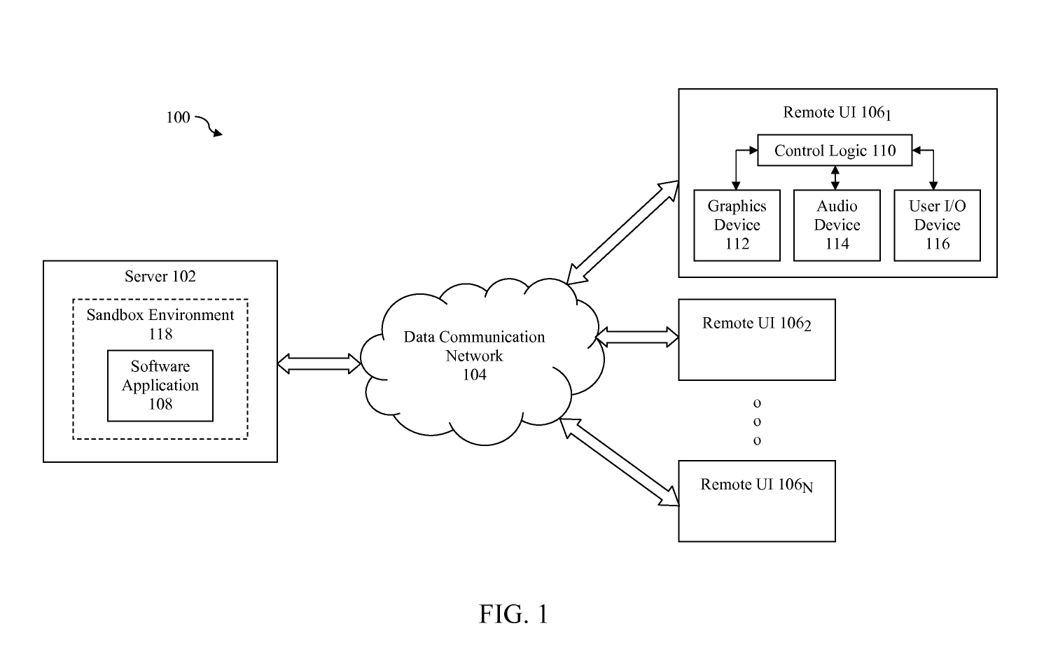

FIG. 1 is a block diagram of an example system 100 that provides a remote user interface for a software application, such as a video game, executing on a computing device such as that described in U.S. patent application Ser. No. 11/204,363. As shown in FIG. 1, system 100 includes a server 102 coupled to one or more remote user interfaces (UIs) 106₁-106_{N} via a data communication network 104. In one exemplary implementation, server 102 and remote UIs 106₁-106_{N} are all located in a user's home and data communication network 104 comprises a wired and/or wireless local area network (LAN). In an alternative exemplary implementation, server 102 is located at the central office or point-of-presence of a broadband service provider, remote UIs 106₁-106_{N} are located in a user's home, and data communication network 104 includes a wide area network (WAN) such as the Internet.

Server 102 is intended to represent a processor-based computing system or device that is configured to execute a software application 108, such as a video game, that is programmed to generate graphics and audio commands for respective hardware devices capable of executing those commands. Software application 108 is also programmed to receive and respond to control commands received from a user input/output (I/O) device and/or associated user I/O device interface. Server 102 represents a native platform upon which software application 108 was intended to be executed and displayed.

In a conventional personal computer (PC), graphics and audio commands generated by a software application such as software application 108 would be received by software interfaces also executing on the PC and then processed for execution by local hardware devices, such as a video and audio card connected to the motherboard of the PC. Furthermore, control commands for the software application would be received via one or more local user input/output (I/O) devices coupled to an I/O bus of the PC, such as a keyboard, mouse, game controller or the like, and processed by a locally-executing software interface prior to receipt by the software application.

In contrast, in accordance with system 100 of FIG. 1, software application 108 is executed within a sandbox environment 118 on server 102. Sandbox environment 118 captures the graphics and audio commands generated by software application 108 and selectively redirects them to one of remote UIs 106₁-106_{N} via data communication network 104. This allows software application 108 to be displayed on the remote UI using the hardware of the remote UI, even though software application 108 may not have been programmed to utilize such remote resources. Furthermore, sandbox environment 118 receives control commands from the remote UI via data communication network 104 and processes them for input to software application 108.

As shown in FIG. 1, remote UI 106₁ includes control logic 110, a graphics device 112, an audio device 114, and a user I/O device 116. Each of the other remote UIs 106₂-106_{N} may include similar features, although this is not shown in FIG. 1 for the sake of brevity. Control logic 110 comprises an interface between data communication network 104 and each of graphics device 112, audio device 114 and user I/O device 116. Control logic 110 is configured to at least perform functions relating to the publication of graphics, audio and user I/O device capability information over data communication network 104 and to facilitate the transfer of graphics, audio and user I/O device commands from server 102 to graphics device 112, audio device 114, and user I/O device 116. Control logic 110 can be implemented in hardware, software, firmware or as a combination of any of these.

Graphics device 112 comprises a graphics card or like hardware capable of executing graphics commands to generate image and video content. Audio device 114 comprises an audio card or like hardware capable of executing audio commands to generate audio content. User I/O device 116 comprises a mouse, keyboard, game controller or like hardware capable of receiving user input and generating control commands therefrom. User I/O device 116 may be connected to remote UI 106₁ using a direct cable connection or any type of wireless communication.

Each of remote UIs 106₁-106_{N} can be a device capable of independently displaying the video content, playing the audio content and receiving control commands from a user. Each of remote UIs 106₁-106_{N} may operate in conjunction with one or more other devices to perform these functions. For example, the remote UI may comprise a set-top box that operates in conjunction with a television to which it is connected to display video content, play audio content, and in conjunction with a user I/O device to which it is connected to receive control commands from a user. As a further example, the remote UI may comprise a PC that operates in conjunction with a monitor to which it is connected to display video content, with a sound system or speakers to which it is connected to play audio content, and in conjunction with a user I/O device to which it is connected to receive control commands from a user.

Although FIG. 1 shows only a single software application 108 executing within sandbox environment 118, it is to be appreciated that multiple software applications may be simultaneously executing within multiple corresponding sandbox environments 118. Consequently, a user of a first remote UI can remotely access and interact with a first software application executing on server 102 while a user of a second remote UI remotely accesses and utilizes a second software application executing on server 102. In this way, more than one user within a home can use different interactive software applications executing on server 102 at the same time that would have otherwise exclusively occupied the resources of server 102.

Additional details concerning the structure, function and operation of system 100 and the components thereof may be found in the aforementioned, incorporated U.S. patent application Ser. No. 11/204,363 entitled “System and Method for Providing a Remote User Interface for an Application Executing on a Computing Device,” which was filed on Aug. 16, 2005 (now U.S. Pat. No. 7,844,442, issued Nov. 30, 2010). As discussed in that application, embodiments of system 100 can provide a low-cost solution to the problem of providing multiple remote user interfaces for using interactive software applications throughout the home. Furthermore, embodiments of system 100 can provide additional benefits in that such embodiments allows software application 108 to be executed on its native computing platform while being accessed via a remote UI, without requiring that software application 108 be programmed to accommodate such remote access. As further described in U.S. patent application Ser. No. 11/204,363, this is achieved through the emulation of local resources by server 102 and the subsequent interception and redirection of commands generated by software application 108 for those local resources in a manner transparent to software application 108. This is in contrast to, for example, conventional X-Windows systems that enable programs running on one computer to be displayed on another computer. In order to make use of X-Windows technology, only software applications written specifically to work with the X-Windows protocol can be used.

Furthermore, because each remote UI 106₁-106_{N} in system 100 need only implement the low-level hardware necessary to process graphics and audio commands transmitted from the computing device, each remote UI 106₁-106_{N} may be manufactured in a low-cost fashion relative to the cost of manufacturing the computing device. Indeed, because each remote UI 106₁-106_{N} need only implement such low-level hardware, each remote UI 106₁-106_{N} can be implemented as a mobile device, such as a personal digital assistant (PDA), thereby allowing an end user to roam from place to place within the home, or as an extension to a set-top box, thereby integrating into cable TV and IPTV networks.

Additionally, because system 100 sends graphics and audio commands from server 102 to a remote UI device rather than a high-bandwidth raw video and audio feed, such an implementation provides a low-latency, low-bandwidth alternative to the streaming of raw video and audio content over a data communication network. Thus, an implementation of system 100 marks an improvement over conventional “screen-scraping” technologies, such as those implemented in Windows terminal servers, in which graphics output is captured at a low level, converted to a raw video feed and transmitted to a remote device in a fully-textured and fully-rendered form.

B. Overview of Remote Gaming Features

As noted above, features associated with a system that provides a remote user interface for an application, such as a video game, executing on a computing device are described herein. Some of these features will now be described at a high level. These features and others will be presented in more detail below. Although the features may be described in relation to the execution of a video game, persons skilled in the relevant art(s) will appreciate that such features may also be used in relation to other types of software applications. As further noted above, the features described herein may be used in conjunction with systems such as those described in aforementioned, incorporate U.S. patent application Ser. No. 11/204,363, although the features described herein may be used with other systems as well. In accordance with such embodiments, references the “server” may refer to server 102 and references to “the client” may refer to any of remote UIs 106₁-106_{N}.

Preservation of User-modified Data. This feature enables user-modified data associated with a video game, such as user settings, saved games, a user profile, or the like, to be maintained between game sessions even when a user's previous and current game sessions are executed on different remote servers or when different users play sessions of the same game on the same remote server. In accordance with a method described herein, the user-modified data is stored in a special storage area on a per-game/per-user basis. In certain implementations, a copy-on-write redirection is used for files and registry keys that are changed by the game during game play.

Rendering Additional Objects into a Game. This feature enables the insertion of additional objects into a game visualization at the server prior to sending it to the client. Objects such as a game cursor or server-side messages may be added to the game scene and streamed as if they were a game object. Alternatively, the additional objects may be inserted into the game visualization at the client.

Logical 3D Compression. The feature enables a compressed stream of 3D commands and/or data to be sent from the server to the client, thereby reducing latency and bandwidth consumption. Various techniques associated with logical 3D compression are described herein, including compression of vertex buffers, compression of matrices, compression of 3D command streams, compression of texture objects per end device, emulating commands on the server side (to avoid synchronized protocol), graphic state management of objects on the server, caching of graphics objects on the client, removing small, insignificant frequently updating particles, and removing small objects from the scene.

Mapping Human Input Device Events to Keyboard and Mouse Events. The goal of this feature is to enable playing games that were designed to be played with keyboard and mouse only with other input devices such as gamepad, touch screen (including multi-touch) and events that are generated from gestures oriented devices.

Fixed DirectX® Pipeline to Programmable OpenGL® Pipeline Conversion. This feature enables the rendering of 3D commands on client graphics processing units (GPUs) that support programmable pipelines only. Modern handheld devices that are now in the market are typically shipped with OpenGL® ES 2.0 capabilities (that includes programmable pipeline only) while DirectX® games usually use a fixed pipeline for rendering a 3D scene.

Adjusting 3D Resources for Better Video Encoding. This feature helps a video encoder on the server to reduce CPU utilization by adjusting resources such as back buffer and depth buffer to the resolution of the streamed video that will be used by the client.

Enabling the Use of the Server as a Home PC. This feature enables an end user to use the server as a home PC while another user is using it for remote game playing. The concept is to hide the window of the game on the server while making it appear as if it is in focus and activated. In this way, the game will use its render functions and the windows-message loop will provide the input for the game.

Running 3D Games with Fake Capabilities. This feature enables the server to run games that requires a specific GPU while it is not installed on the server.

Audio Interception. This feature enables the “remote gaming” solution to intercept the audio of the game and prevent it from being played on the server. The intercepted audio is mixed, encoded and streamed to the end-device for decoding and playback.

Other features described herein include converting vertex changes to matrices and rendering the cursor on the client side.

### II. Example System Overview

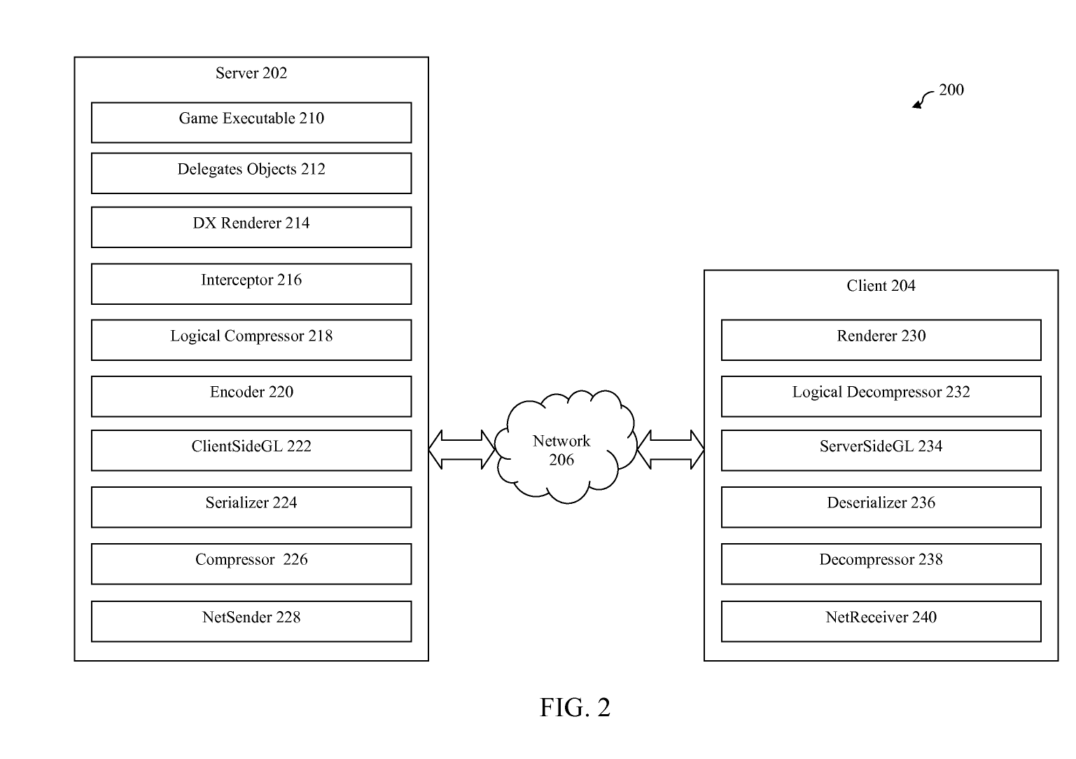

FIG. 2 is a block diagram of an example system 200 that provides remote gaming features in accordance with an embodiment. As shown in FIG. 2, system 200 includes a client 204 that is connected to a server 202 via a network 206. Client 204 issues a command over network 206 to server 202 to start a software application. For the remainder of this description, it will be assumed that the software application comprises a video game, although the invention is not so limited. Server 202 is configured to determine where a game executable 210 for the video game is located and execute it. Using various hooking mechanisms, software executing on server 202 intercepts commands from game executable 210 to selected software libraries. The software libraries may include, for example, a DirectX® API library, an OpenGL® API library, a kernel API library, or any other software library. In one embodiment, server 202 comprises server 102 of FIG. 1, client 204 comprises one of remote UIs 106₁-106_{N}, and network 206 comprises data communication network 104.

When video game executable 210 issues commands such as graphics rendering commands, including but not limited to commands to a DirectX® or OpenGL® API, the software on server 202 intercepts the commands, processes the intercepted commands, and send the commands over network 206 to client 204 where the commands are executed and the game graphics are rendered.

In certain embodiments, the same hooking mechanism that is used to intercept functions to a library or DLL is also used to send the commands over network 206 to client 204 where the commands are executed. Furthermore, the interception is not limited to a single library and it is possible to intercept commands directed to multiple libraries and distribute the commands to multiple computing devices, thereby utilizing additional computing power to execute the software application even though the software application was originally designed to be executed on a single computing device. Consequently, the system can provide a CORBA (Common Object Request Broker Architecture) or DCOM (Distributed Component Object Model) like interface that enables a software application to be executed in a distributed manner across multiple computing devices even though the software application was originally written by a developer to execute on a single computing device.

FIG. 2 depicts various software modules resident on client 204 and server 202 that are used in this process in accordance with a particular example implementation. Taken together, these software modules may be thought of as providing a graphics streaming pipeline from server 202 to client 204. Additional details relevant to such an implementation will be provided below. It is to be understood that these details are provided by way of example only, and that various other software modules may be used in accordance with alternative implementations.

As shown in FIG. 2, the software modules installed on server 202 include game executable 210, a Delegates Objects module 212, a DX Renderer module 214, an Interceptor module 216, a Logical Compressor module 218, an Encoder module 220, a ClientSideGL module 222, a Serializer module 224, a Compressor module 226 and a NetSender module 228.

Game executable 210 comprises standard computer code for a video game that is executed within the context of the operating system running on server 210.

Delegates Objects module 212 is configured to perform the graphics API interception. Typically, a graphics API such as DirectX is object-oriented. Thus, in one embodiment, Delegates Objects module 212 implements a proxy of the DirectX objects that are created by the DirectX API. Delegates Objects module 212 also stores locally-cached game state to answer object queries immediately. This will be described later as a way of improving performance.

DX Renderer module 214 is a component that is used to provide a variety of features. For example, DX Renderer module 214 allows the game graphics to be rendered by graphics hardware on server 202 to a display associated with server 202 (not shown in FIG. 2), which is useful for debugging. In case there is a need to stream the game from server 202 in video format, DX Renderer module 214 is capable of issuing commands on server 202 to render a frame, capture the frame and transferring the frame to encoder module 220.

Interceptor module 216 is configured to perform at least two main tasks. First, interceptor module 216 maintains the render state of each graphics object on server 202. This function is performed in this layer to separate the graphic interception layer from the graphic state management. Second, interceptor module 216 passes to the next module in the graphics pipeline only changes in the graphic state so that the subsequent layers in the pipeline will perform their tasks only when needed.

Logical Compressor module 218 is responsible for performing compression based on the rendering logic. A number of compression algorithms will be described herein that take advantage of the fact that the changes between one frame to be rendered and the next are often small. Despite this, video game applications are typically programmed to re-send all the commands and data for each frame.

Encoder module 220 is responsible for converting the API commands to a standard API that can be handled on server 202. Many games use DirectX® (there are various versions of DirectX® as released by Microsoft Corporation of Redmond, Wash. from time to time) but DirectX® is supported only on Microsoft Windows® operating systems. In order to ensure that a variety of client devices and configurations can be supported, OpenGL® is used as the rendering API on the client in accordance with one embodiment. Accordingly, Encoder module 220 is responsible for translating all DirectX® commands to OpenGL® commands.

ClientSideGL module 222 is responsible for handling certain OpenGL® ES 2.0 optimizations that are implemented on server 202. For example, due to some restrictions of the OpenGL® ES 2.0 specification, uniforms (shader input) are defined per-program, which means that the same data should be sent over and over for each program. ClientSideGL module 222 manages the uniforms in a way that causes the uniforms to be cached. For example, a projection matrix which is likely to stay the same for most of the objects in a scene must be defined at least once for each shader (shaders are changing when rendering state changes).

Serializer module 224 serializes OpenGL® commands to a protocol based on GLX, the OpenGL® Extension to the X Window System.

Compressor module 226 uses a block compression algorithm to compress each block of data that is sent to client 204. For example, Compressor module 226 can utilize the ZIP data compression algorithm or some variation thereof. Compressor module 226 preferably utilizes a data compression algorithm that has very short processing time.

NetSender module 228 is responsible for sending blocks of commands and data to client 204. In order not to “flood” client 204 with commands at a rate that client 204 cannot render, a protocol that controls the rate at which commands are delivered is implemented on both client 204 and server 202 (i.e., in NetSender module 228 and a NetReciever module 240). In accordance with this protocol, server 202 sends a block to client 204 as long as client 204 sends an acknowledgement indicating that a previously-sent block was received. The “window” of blocks that comprise the difference between client 204 and server 202 is dynamic and changes according to the block size and the delay of the block processing.

As further shown in FIG. 2, the software modules installed on client 204 include a NetReceiver module 240, a Decompressor module 238, a Deserializer module 236, a ServerSideGL module 234, a Logical Decompressor module 232 and a Renderer module 230. NetReciever module 240 receives the blocks of data sent by server 202 as described above in reference to NetSender module 228. Decompressor module 238 decompresses the blocks of data using the same algorithm as used by the compressor module 226 on server 202. Deserializer module 236 parses the decompressed blocks of data and extracts OpenGL® commands therefrom. ServerSideGL module 234 essentially does the opposite of ClientSideGL module 222 and assigns the uniforms needed for each program. Logical Decompressor module 232 extracts the data that was compressed by Logical Compressor module 218 on server 202. Renderer module 230 renders the graphics commands on client 204, wherein rendering the graphics commands comprises utilizing graphics hardware to render graphics objects to a display associated with client 204 (not shown in FIG. 2).

### III. Example Remote Gaming Features

Various features will now be described that can be implemented in a system such as system 200 of FIG. 2 described in the preceding section to enhance the system, and in particular improve its performance and usability. Technical details associated with example implementations of such features will also be provided. All of the features described in this section depend on interception mechanisms that are applied to system libraries such as DirectX® API libraries and others. However, it is to be understood that the technical details provided herein are provided by way of example and are not intended to be limiting.

A. Preservation of User-Modified Data

In accordance with one embodiment, when executing a video game application on a server, such as server 202, and transmitting the display-related data to the client, such as client 204, the video game application is actually executed on the server and saved data associated with the video game application is stored on the server rather than the client. The saved data may include, for example, game settings saved in a configuration file, saved game files that include the progress of a particular user in the video game, and other files that may be used by the video game.

In accordance with one embodiment, there are many servers that can potentially serve a specific user and multiple users may use the same server in order to run the same video game application. As a result, there is a need to manage the saved data in such a way that when each user is running the video game application, he will be able to use his previous settings and saved files even if in the previous game session he executed the video game application on a different server or another user used the server he is currently using to run the same video game application.

In an embodiment, this saved data management is achieved by having the server identify the user and associating a user ID with the same user for all the user's gaming sessions. Video game applications typically do not support this functionality natively as such applications have been designed to be executed on an end user machine at home and not on a server farm shared by multiple users. One manner of implementing this functionality will now be described.

To manage the user-modified data, all the NT API from system dynamic link libraries (such as ntdll.dll and kernel32.dll) that use handles and all other I/O API are intercepted.

Generally, all the hooked functions are called in a pass-through manner. This means that the original API is called with all the given parameters. A handle mapping is stored and maintained for each handle that is returned from the native API. The original handle of the original file is mapped to an application-specific handle. The application-specific handle is returned to the video game for future use. In cases where the video game tries to change the content of the file or registry element, the original file or registry element is copied to a pre-defined target folder or registry key that is associated with the user running the game and the mapped handle is replaced in the mapping storage to be associated with the new file (substitute) or registry copy created. All the successive I/O operations on this handle are performed on the new file or registry element.

When the video game tries to open a file or registry element that already has a redirected substitute as described above, the substitute is opened and the handle is stored in the mapping storage.

To enable enumeration of folders and registry keys, the mapping storage stores two handles for each opened handle, one for the original folder/registry key and one for the redirected folder/registry key. When the game enumerates files in a folder or registry values in a registry key, the content of the original and target folder/registry key are merged.

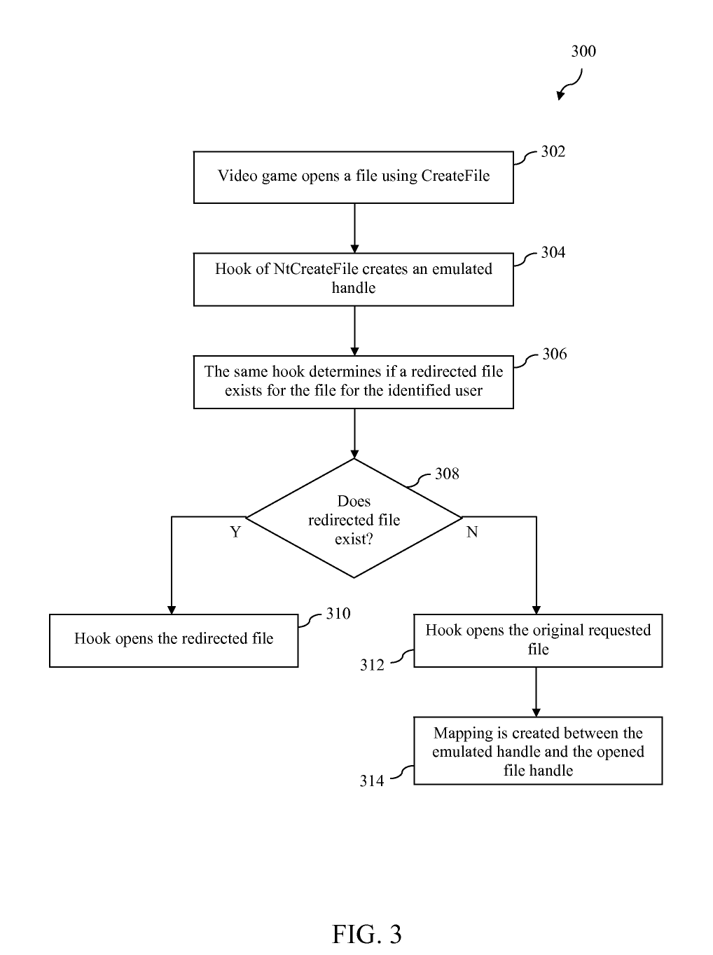

For example, FIGS. 3, 4 and 5 depict flowcharts of methods 300, 400 and 500, respectively, for preserving user-modified data associated with a video game in accordance with the foregoing. In particular, FIG. 3 shows steps that occur responsive to the video game opening a file. As shown in FIG. 3, the method of flowchart 300 begins at step 302, during which the video game opens a file using the CreateFile command. At step 304, a hook of NtCreateFile creates an emulated handle. At step 306, the same hook determines if a redirected file exists for the file being opened for the identified user of the video game. In accordance with decision step 308, if the hook determines that a redirected file exists for the file being opened for the identified user, then the hook opens the redirected file as shown at step 310. However, in further accordance with decision step 308, if the hook determines that a redirected file does not exist for the file being opened for the identified user, then the hook opens the original requested file as shown at step 312 and then creates a mapping between the emulated handle and the opened file handle as shown at step 314.

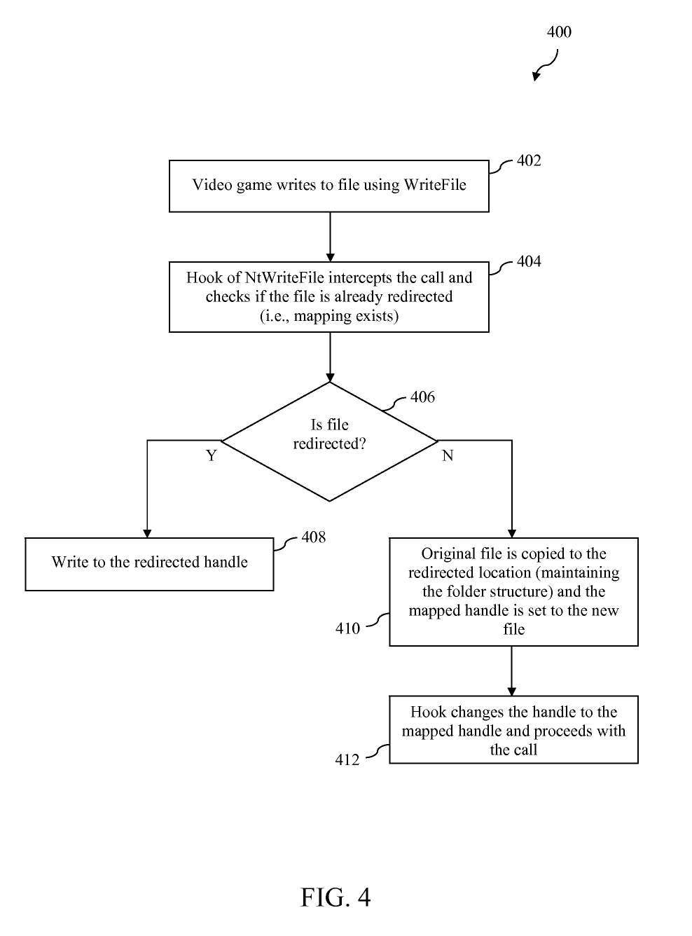

FIG. 4 shows steps that occur responsive to the video game writing to a file. As shown in FIG. 4, the method of flowchart 400 begins at step 402 in which the video game writes to the file using the WriteFile command. At step 404, a hook of NtWriteFile intercepts the call and checks if the file is already redirected (i.e., that a mapping exists). In accordance with decision step 406, if the file is redirected, then the hook writes to the redirected handle as shown at step 408. However, in further accordance with decision step 406, if the file is not redirected, then the original file is copied to the redirected location (maintaining the folder structure) and the mapped handle is changed to the new file as shown at step 410. Then, at step 412, the hook changes the handle to the mapped handle and proceeds with the call.

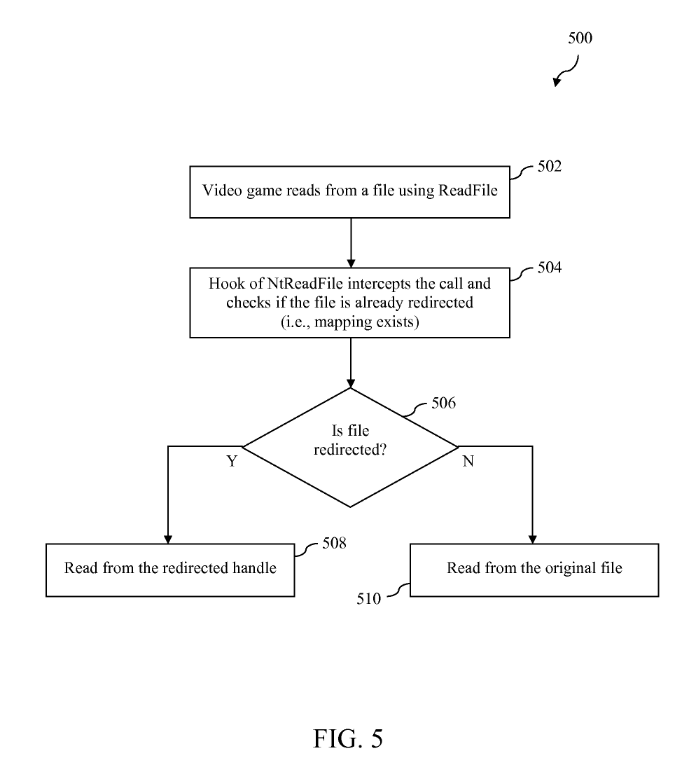

FIG. 5 shows steps that occur responsive to the video game reading to a file. As shown in FIG. 5, the method of flowchart 500 begins at step 502 in which the video games reads from the file using the ReadFile command. At step 504, a hook of NtReadFile intercepts the call and checks if the file is already redirected (i.e., that a mapping exists). In accordance with decision step 506, if the file is redirected, then the hook reads from the redirected handle as shown at step 508. However, in further accordance with decision step 506, if the file is not redirected, then the hook reads from the original file as shown at step 510.

Although FIGS. 3-5 describe particular methods for preserving user-modified data associated with a video game, persons skilled in the relevant art(s) will appreciate that the invention is not limited to these particular methods.

B. Rendering of Additional Objects into a Video Game

It may be desired to render overlay information in addition to the graphics normally presented by a video game. For example, in order to allow a user to exit a first video game quickly and select a second video game it may be desired to display an overlay menu that allows that, even though both the first video game and the second video game are not programmed to display the overlay menu. A further example of additional graphic content that may be rendered into a video game is display ads that were not originally coded into the video game. A still further example is additional game help information. Since video games are executed on the server (e.g., server 202), the user may not have received a game manual or help files associated with the video game. Additionally, since the client (e.g., client 204) may be a computing device of a type (e.g., a TV or mobile device) that is different than the type of computing device for which the game was programmed, it may be necessary to provide a mapping of game controls. For example, a mapping from keyboard and/or mouse controls to gamepad or mobile phone controls may need to be provided. Accordingly, additional game help information may be inserted into the video game to allow a user to open help screens that were not originally coded into the game, to allow the users to get help, control mappings, etc.

The option to add additional graphics may be implemented on the server side where the game process is executed. For example, the option to add additional graphics may be implemented on server 202 of system 200. When hooking the graphics commands, it is possible to inject additional commands that will display the additional graphics. Another option is to implement the same logic on the client side before presenting the graphics on the screen. For example, the same logic may be implemented on client 204 before presenting the graphics on a display associated with client 204. Example techniques for using interception to dynamically render additional graphic content within the context of an executing computer game are described in commonly-owned U.S. Pat. No. 7,596,540, issued on Sep. 29, 2009 and entitled “System, Method and Computer Program Product for Dynamically Enhancing an Application Executing on a Computing Device,” the entirety of which is incorporated by reference herein.

To add an additional object to a game scene, a three-dimensional (3D) element may be created when it is needed. Usually, a single 3D element is created in the beginning of a scene and is used later during game play. The 3D element may be rendered into the scene using standard 3D commands. In accordance with one embodiment, immediately after rendering the object into the scene, the original graphic state of the GPU is restored. A preferable approach for making sure that the additional object will remain on top of the scene is to call the drawing commands just before the end-scene command is called.

In another example, the game may be resized in order to allow rendering of additional graphics around the game. Example techniques for using interception of graphics commands to dynamically resize a game and display additional content around an executing computer game are described in commonly-owned co-pending U.S. patent application Ser. No. 11/779,391, filed Jul. 18, 2007 and entitled “Dynamic Resizing of Graphics Content Rendered by an Application to Facilitate Rendering of Additional Graphics Content.” The entirety of this application is incorporated by reference herein.

C. Logical 3D Compression

One of the important issues related to distributed computing, especially for applications such as video games, is the sensitivity to delay and bandwidth. It is desirable to reduce delay and bandwidth as much as possible in order to provide users with the best user experience possible. This section describes a set of optimizations that may be used in conjunction with the streaming of graphics commands from a server to a client that can significantly improve streaming performance.

1. Compression of Vertex Buffers

Vertex buffers were introduced as part of Direct3D® 8.0 as a way of creating a rendering pipeline system that allows the graphics processing to be shared by both the central processing unit (CPU) and the GPU of the video hardware. Vertex buffers provide a mechanism by which vertex buffer data can be filled in by the CPU, while at the same time allowing the GPU to process an earlier-generated batch of vertices. A vertex buffer is optimized to by the device driver for faster access and flexibility within the rendering pipeline.

A vertex buffer describes a 3D model. Vertex description in a vertex buffer can consist of position, normal, tangent/bionormal, a set of up to 8 texture coordinates, a set of up to 3 vertex weights and a set of up to 2 colors (diffuse and specular). All the vertex description components are floats except for colors.

Video games can use the CPU to change the content of a vertex buffer in each frame for animation and other movements.

This section described a method for representing changes that have been made to the vertex buffer by a video game from a previous frame to a current frame. A resulting buffer that represents the changes is sent from the server to the client (e.g., from server 202 to client 204). The client uses the description and applies the changes to the vertex buffer that is being used by the client GPU.

The method provided in this section describes the compression of DirectX drawing commands that use vertex buffers. However, the method is easily projected to DirectX drawing commands that don't use vertex buffers (such as DrawPrimitiveUP, DrawIndexedPrimitiveUP), to OpenGL drawing commands, and to other drawing commands.

The general idea is to calculate distances between a previous position and a current position of a vertex and deliver only the distance. Distances can be represented with less data than the position itself. On the client side, the vertex is “moved” by this distance to obtain the required current position. Sometimes, vertices are moving together to the same direction so the calculated distance to the “neighbor” of a vertex can result with a lower number.

In one embodiment, for each vertex buffer, a copy of a previous vertex buffer is held. To reduce floating point inaccuracies and to ensure that the values are the same in the server and in the client, the same data that was calculated by the client is stored on the server instead of plain copying it.

The vertex buffer used in a current drawing command is scanned to ensure that only the vertices that were changed are processed. If the drawing command uses indices (when the game uses DrawIndexedPrimitive), the vertices are scanned according to the index buffer (omitting vertices that were already visited), otherwise (when the game uses DrawPrimitive) they are scanned linearly.

The encoding of vertex components depends on data type (float/char). If a component has more than one value (for example—normal is 3 floating point values), the compression is applied separately for each value.

Encoding of color (char) components may be achieved as follows: the encoded color value is a difference between the current color value and previous color value of the vertex. On the client side, the logical decompressor adds the received value to the previous color value for that vertex. The reason for adopting this approach is that color values rarely change. Another possible implementation could be based on comparing color values of neighboring vertices, since color values are frequently close (if not equal) for most of the vertices in a mesh.

For encoding of floating points values of a vertex Vᵢ, 4 differences (D₀−D₃) must first be calculated as follows:

D₀ is the difference between the current value of V, and the previous value of Vᵢ.

D₁ is the difference between the current value of Vᵢ₋₁ and the previous value of Vᵢ₋₁.

D₂ is the difference between the current value of Vᵢ₋₂ and the previous value of Vᵢ₋₂.

D₃ is the difference between the current value of Vᵢ₋₃ and the previous value of Vᵢ₋₃.

Note that Vᵢ₋₁−Vᵢ₋₃ are not necessarily neighbors of the current vertex in a primitive (as in a triangle representation).

Note also, that scanning indexed meshes in order of their indices is more likely to produce sequences of neighboring vertices, which is good for encoding.

In case there are no previous values (i.e., when processing 4 first vertices), the appropriate differences are not used.

D₀−D₃ and all other intermediate and final floating point values are converted to fixed point format with 12 bits in the fraction part and 20 bits in the integer part. In a case in which the value cannot be represented properly using such precision, the value is not used. In all following operations comparison and arithmetic operations, fixed point values are used as integers.

Differences are calculated to create 4 possible encoded values:
E₀=D₀ (in cases in which the vertex moved a little then this value will be small);
E₁=D₀−D₁ (in cases in which the vertex and its first neighbor moved in the same vector);
E₂=D₀−(D₁+D₂)/2 (in cases in which the vertex is a part of a triangle and all the vertices of the triangle moved together); and
E₃=D₀−(D₁+D₂−D₃) (in cases in which the vertex is a part of a diamond shape and the predicted vertex lies on or close to the diagonal of the diamond).

The smallest encoded value is then chosen as the encoded value of the current floating point value. If none of the differences D₀-D₃ were usable (for example, because there were no previous values or because the floating point values couldn't be converted to fixed point), the real value of the vertex is used. In each case a control data (1 byte) for the encoded value indicates the type of encoding that was used so that the logical decompressor on the client side will be able to reverse the calculations. The control data is appended to the end of the encoded buffer, this way the original buffer size is increased by up to 25% of its original size. The resulted encoded buffer contains small numbers that are more compressible.

For example, consider a vertex buffer with the following positions:
VB₀={(0,1,0), (−1,0,1), (2,2,0)}
   And assume the game edits the vertex buffer to new positions:
VB_{A}={(3,1,1), (0,0,1), (1,2,0)}
   To compress the value of x-position of the first vertex in the new vertex buffer, we calculate:

D₀=3−0=3

D₁=0−(−1)=1

D₂=1−2=−1
D₃ is unavailable

E₀=3

E₁=3−1=2

E₂=3−(1+−1)/2=3

E₃=3−(4+3−0)=−4

The encoded x-position is min(abs(E₀), abs(E₁), abs(E₂), abs(E₃))=2.

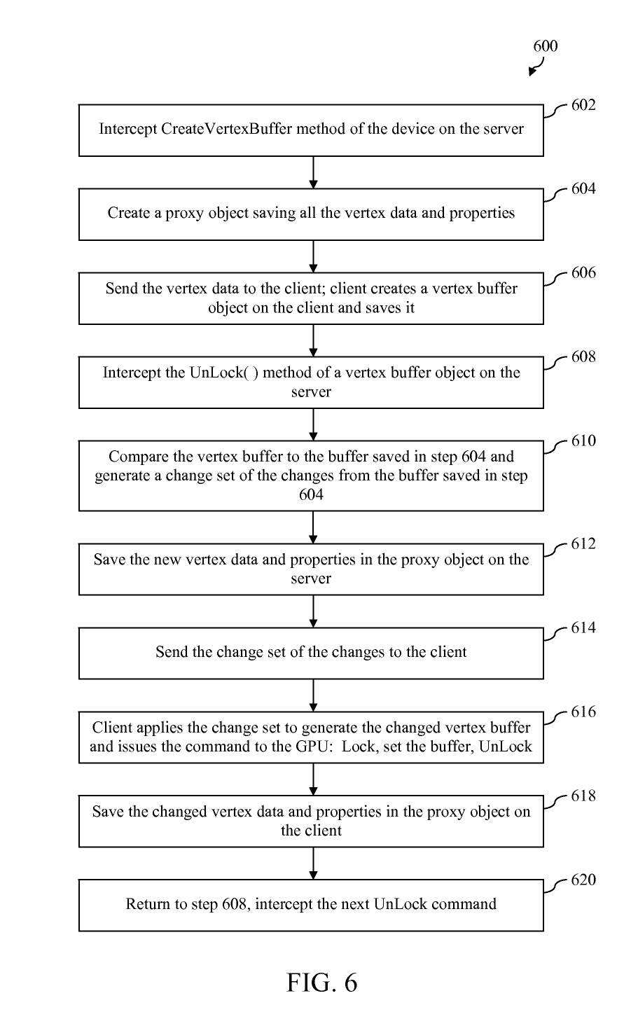

FIG. 6 depicts a flowchart 600 of one method for performing compression of vertex buffers in accordance with an embodiment of the present invention. The method of flowchart 600 may be implemented, for example, by software components on server 202 and client 204 of system 200 as described above in reference to FIG. 2, although the method is not limited to those embodiments. Furthermore, the method of flowchart 600 represents only one manner of performing compression of vertex buffers and is not intended to be limiting.

As shown in FIG. 6, the method of flowchart 600 begins at step 602, in which a CreateVertex Buffer method of a device is intercepted on the server. At step 604, a proxy object is created on the server that saves all the vertex data and properties. At step 606, the vertex data is sent to the client and the client creates a vertex buffer object on the client based on the vertex data and saves the vertex buffer object. At step 608, an UnLock( ) method of a vertex buffer object on the server is intercepted. At step 610, the vertex buffer referenced by step 608 is compared to the vertex buffer saved during step 604 and, based on this comparison, a change set of the changes from the vertex buffer saved during step 604 is generated. At step 612, the new vertex data and properties are saved in the proxy object on the server. At step 614, the change set of the changes are sent to the client. At step 616, the client applies the change set to generate the changed vertex buffer and issues the command to a GPU of the client: Lock, set the buffer, UnLock. At step 618, the changed vertex data and properties are saved in the proxy object on the client. At step 620, control returns to step 608 in which the next UnLock command is intercepted.

2. Compression of Matrices

In software applications that work with 3D graphics, one can use geometrical transforms on vertex buffers to do the following: (1) express the location of an object relative to another object; (2) rotate and size objects; and (3) change viewing positions, directions, and perspectives. Each matrix may be represented by a vector of 16 floats (float=4 bytes) that represent the 4×4 matrix.

Translate. The following transform translates the point (x, y, z) to a new point (x′, y′, z′):

$$[ \begin{matrix}1 & 0 & 0 & 0 \\ 0 & 1 & 0 & 0 \\ 0 & 0 & 1 & 0 \\ {T}_{x} & {T}_{y} & {T}_{z} & 1\end{matrix} ]$$

Scale. The following transform scales the point (x, y, z) by arbitrary values in the x-, y-, and z-directions to a new point (x′, y′, z′):

$$[ \begin{matrix}{S}_{x} & 0 & 0 & 0 \\ 0 & {S}_{y} & 0 & 0 \\ 0 & 0 & {S}_{z} & 0 \\ 0 & 0 & 0 & 1\end{matrix} ]$$

Rotate. The transforms described here are for left-handed coordinate systems, and so may be different from transform matrices that you have seen elsewhere.

The following matrix rotates the point (x, y, z) around the x-axis, producing a new point (x′, y′, z′):

$$[ \begin{matrix}1 & 0 & 0 & 0 \\ 0 & cos θ & sin θ & 0 \\ 0 & - sin θ & cos θ & 0 \\ 0 & 0 & 0 & 1\end{matrix} ]$$

The following matrix rotates the point around the y-axis:

$$[ \begin{matrix}1 & 0 & 0 & 0 \\ 0 & cos θ & sin θ & 0 \\ 0 & - sin θ & cos θ & 0 \\ 0 & 0 & 0 & 1\end{matrix} ]$$

The following matrix rotates the point around the z-axis:

$$[ \begin{matrix}cos θ & sin θ & 0 & 0 \\ - sin θ & cos θ & 0 & 0 \\ 0 & 0 & 1 & 0 \\ 0 & 0 & 0 & 1\end{matrix} ]$$

In these example matrices, the Greek letter θ (theta) stands for the angle of rotation, in radians. Angles are measured clockwise when looking along the rotation axis toward the origin.

Projection. One can think of the projection transformation as controlling the camera's internals; it is analogous to choosing a lens for the camera. This is the most complicated of the three transformation types.

There are several ways to compute the projection matrix, but it will most likely end up with the following form:

$$[ \begin{matrix}a & 0 & 0 & 0 \\ 0 & b & 0 & 0 \\ 0 & 0 & b & e \\ 0 & 0 & d & 0\end{matrix} ]$$

All the matrices used by a video game will be a one of or a concatenation of matrices of the aforementioned types. In accordance with one embodiment, the matrix buffer is compressed by using this knowledge and based on the assumption that the video game is using matrices of these types.

A control byte may be used to indicate which matrix compression type is used. The matrix type can be one of: translation, scale, rotation around x-axis, rotation around y-axis, rotation around z-axis, projection matrix, generic compressible matrix and uncompressed matrix. A generic compressible matrix is a matrix in which at least one value is 0.

In case the matrix type is one of translation, scale, rotation or projection matrix, the data following the control byte may be the variable values of the matrix itself. There will be 3 floats for translation and scale matrices, 1 float for a rotation matrix (the angle of the rotation), and 5 floats for a projection matrix. For example, the translation matrix may be compressed to a 13-byte buffer:
[Type:1 byte][Tₓ: 4 bytes] [T_{y}: 4 bytes] [T_{z}: 4 bytes]

In a case in which the type is uncompressed, all the 16 values are delivered as is. In a case in which the type is generic compressible, 2 additional bytes (16 bits) are added that indicate the non-zero values using the bits as a matrix mask. The rest of the values are delivered as floats.

$$[ \begin{matrix}{M}_{11} & {M}_{12} & 0 & 0 \\ 0 & {M}_{22} & {M}_{23} & {M}_{24} \\ 0 & 0 & {M}_{33} & {M}_{34} \\ 0 & {M}_{42} & {M}_{43} & 0\end{matrix} ]$$

For example, compression the matrix above will result with the following buffer:

[Type:1 byte][Mask: 2 bytes] [M₁₁: 4 bytes] [M₁₂: 4 bytes] [M₂₂: 4 bytes]

[M₂₃: 4 bytes] [M₂₄: 4 bytes] [M₃₃: 4 bytes] [M₃₄: 4 bytes] [M₄₂: 4 bytes]

[M₄₃: 4 bytes]

where the bitwise representation of Mask is 1100 0111 0011 0110.

3. Compression of 3D Command Streams

In order to display an object on the screen, a video game may be required to issue several graphics commands that change the graphic state of a GPU and then issue another command that draws an object on a back buffer. Then, when the video game issues a command that replaces a front buffer with the back buffer (Present in DirectX and SwapBuffers in OpenGL), the frame is presented on the screen.

When the video game presents the same 3D object at the same place on the screen frame after frame, it may use the same set of graphics commands and parameters in each frame. Moreover, sometimes, the same sets of commands are applied to several objects and some of the parameters of those commands are the same for all the objects. For example, when changing the position of a complex object, the same matrices may be used for all the parts of the object.

For this reason, a video game application may generate the same sequence of graphics commands over and over during execution. By encoding such sequences to a single identifier, an embodiment reduces the amount of data that must be transferred from the server to the client. In cases in which the parameters of the commands are different in each execution, the parameters can be encoded separately and delivered to a separate buffer so that when the logical decompressor on the client detects an encoded identifier of a sequence of commands, it will have the parameters of those commands immediately when it needs to execute them on a local GPU.

For example, in order to set up the graphic state of a GPU and draw an object on a back buffer a video game may use the following set of DirectX® commands:

SetRenderState—to enable light

SetRenderState—to enable alpha blending

SetTextureStageState—to combine textures on different stages

SetSamplerState—to define the texture filtering

SetTexture—to set the texture of the object

SetStreamSource—to set the vertex buffer

DrawPrimitive—to draw the object on the back buffer

This sequence of commands, along with the associated parameters, will be repeated for each frame in a series of frames in which the object remains the same.

In accordance with one embodiment, when running a video game on the server, such command sequences are detected by tracking the render state of a GPU that comprises part of the server. All the commands that change the graphic state of the GPU are tracked and are not sent to the client until a drawing command is issued. When a drawing command is issued, the current graphic state of the GPU is encoded into a set of commands. The set of commands is inserted into a cache and given an identifier. The cache may be managed using a least-recently used (LRU) algorithm. The client manages the same dictionary of sequences. If the server detects a sequence that was already sent, it can send only the sequence identifier to the client instead. The client uses the identifier to obtain the sequence of commands from its internal dictionary and issues them on its local GPU. When the server detects a new identifier, the whole sequence is sent to the client (encoded with additional encoding) to be stored as part of the client's dictionary.

An extension of the above method is to actually save the commands issued for a frame on both the client and the server. During processing of the next frame, it is possible to check for differences between the commands and data associated with the two frames and send only the differences to the client. As a result, fewer commands and less data are transferred and the client can re-render commands that are the same for the current frame, remove commands that do not exist anymore and add the new commands. Only the difference between the commands is sent over the network. If the software module on the server that compares the commands associated with the previous frame to the commands associated the new frame determines that such compression will not be effective because the representation of the differences between the command sequences is larger than the commands associated with the new frame, it can simply transmit the commands associated with the new frame. This may be thought of as an example of a key frame as is used in video compression.

To effectively manage the algorithm it may be desired to manage the commands and the data (commands parameters) separately as in some cases the commands may repeat but with updated command parameters. This may result in better compression at the layer of the logical compressor.

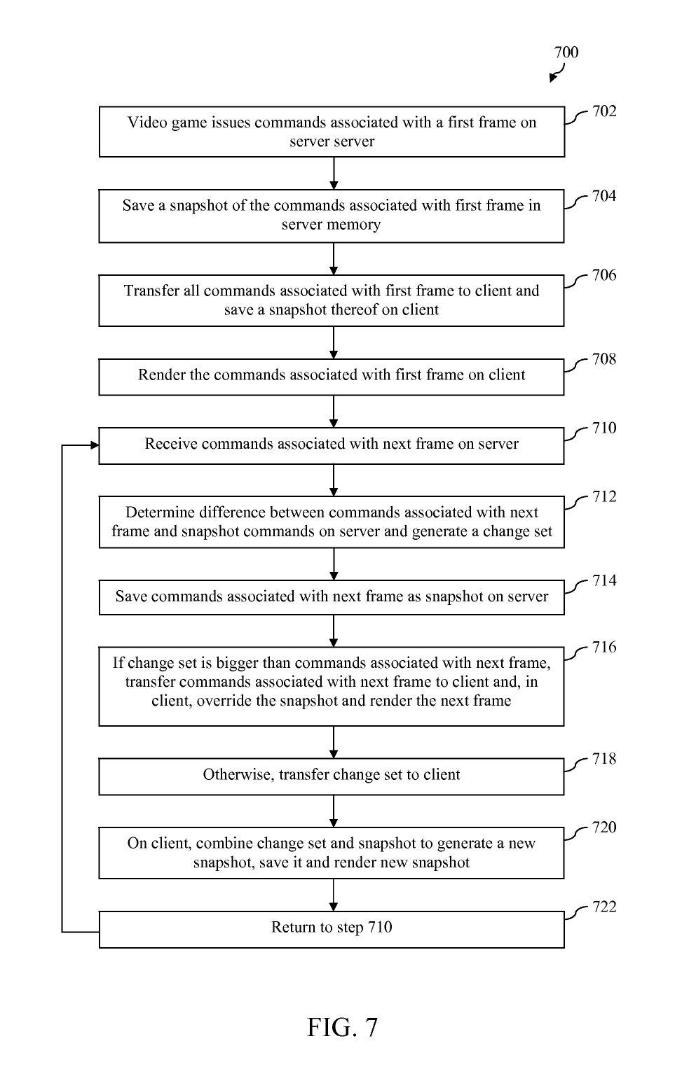

FIG. 7 depicts a flowchart 700 of one exemplary method for performing compression of a 3D command stream in accordance with an embodiment of the present invention. The method of flowchart 700 may be implemented, for example, by software components on server 202 and client 204 of system 200 as described above in reference to FIG. 2, although the method is not limited to those embodiments. Furthermore, the method of flowchart 700 represents only one manner of performing compression of a 3D command stream and is not intended to be limiting.

As shown in FIG. 7, the method of flowchart 700 begins at step 702, in which a video game executing on the server issues commands associated with a first frame. At step 704, a snapshot of the commands issued during step 702 is saved in local memory of the server. At step 706, all of the commands associated with the first frame are transferred to the client and the client also saves a snapshot thereof. At step 708, the client renders the commands associated with the first frame.

At step 710, commands associated with a next frame are issued by the video game executing on the server and received. At step 712, a difference between the commands associated with the next frame and the snapshot of the commands associated with the first frame is determined to generate a change set. There are many existing algorithms that can be used to calculate differences between two sets of data and any of them may be used to perform this step. At step 714, the commands associated with the next frame are saved as the snapshot on the server. At step 716, if it is determined that the size of the change set obtained during step 712 is larger than the size of the commands associated with the next frame, then the commands associated with the next frame are transferred to the client and, at the client, the commands in the previously-saved snapshot are overwritten and the next frame is rendered using the commands associated therewith. However, as shown at step 718, if it is determined that the size of the change set obtained during step 712 is not larger than the size of the commands associated with the next frame, then the change set is transferred to the client and, at step 720, the client combines the change set and the previously-saved snapshot to generate a new snapshot. As further shown at step 720, the client saves the new snapshot and renders the commands included therein. At step 722, control returns to step 710 in which commands associated with the next frame to be rendered are received on the server.

4. Compression of Texture Objects Per End-User Device

A mipmap is a sequence of textures, each of which is a progressively lower resolution representation of the same image. The height and width of each image, or level, in the mipmap is a power of two smaller than the previous level. Mipmaps do not have to be square.

A high-resolution mipmap image is used for objects that are close to the user. Lower-resolution images are used as the object appears farther away. Mipmapping improves the quality of rendered textures at the expense of using more memory.

In order to deliver less data to the client, an embodiment transfers only the highest resolution texture from the server to the client. On the client, all the mipmaps are reconstructed using the most detailed texture that was transferred. By doing this, the amount of transferred data can be reduced by 50%.

In addition, the texture itself can be compressed in accordance with an embodiment. For example, textures transferred from the server to the client can be compressed using a texture compression algorithm providing a constant compression ratio such as DXT. Other image compression algorithms can also be used that preserve the image details such as transparency. For example, JPEG 2000 and PNG are well-known image compression algorithms that may be suitable for that purpose. On the client side, the original texture format can be reconstructed from the compressed image.

5. Emulating Commands on the Server Side

Video games and game engines utilize graphic libraries API in order to present a game visualization. API calls generated by the video games and game engines are translated by the graphic libraries into GPU commands that change the graphic state of a GPU. In order to achieve a desired visualization, a video game may ensure that the graphic state of a GPU is correct by using the result of a graphic library API call. Moreover, some commands issued by the video game or game engine may depend on the result of a previously-issued command. For example, the command SetTexture can be called using a texture that was successfully created. This means that SetTexture cannot be called unless the API CreateTexture returned successfully with the created texture.

When creating a remote user interface such as that described herein, it is important that the server does not have to wait for a result of a command sent to the client. It is desirable to create a fully asynchronous protocol in which the server can stream commands to the client.

In order to avoid the use of a synchronized protocol, an embodiment utilizes commands emulation. In accordance with such an embodiment, a proxy that exposes all the graphic library API to a video game game processes each command generated by the video game on a virtual object and returns a reasonable expected result to the video game immediately without waiting for the client to actually execute the command and return a response to the server.

An example involving texture creation will now be provided. When a video game tries to create a new texture, the aforementioned proxy creates a texture proxy object and returns to the video game an object that implements the texture interface and that can be used by the game as a texture object. In the texture proxy object, all the memory and resources that can be used by the video game are allocated. The texture object is sent (in encoded form) to the client only when it is first used, and the client creates a local texture on its local GPU with the same attributes that are used in the texture proxy. So, the video game continues its execution before a texture is actually created on the client side. This can apply to all the 3D commands used by the video game.

By creating the proxy object on the server, the video game is allowed to continue execution without having to wait for the actual object to be created on the client. In this way, the server can stream commands to the client without having to wait for the client response. The same approach can be applied to additional software libraries and as such create an asynchronous stream of commands from the server to a client.

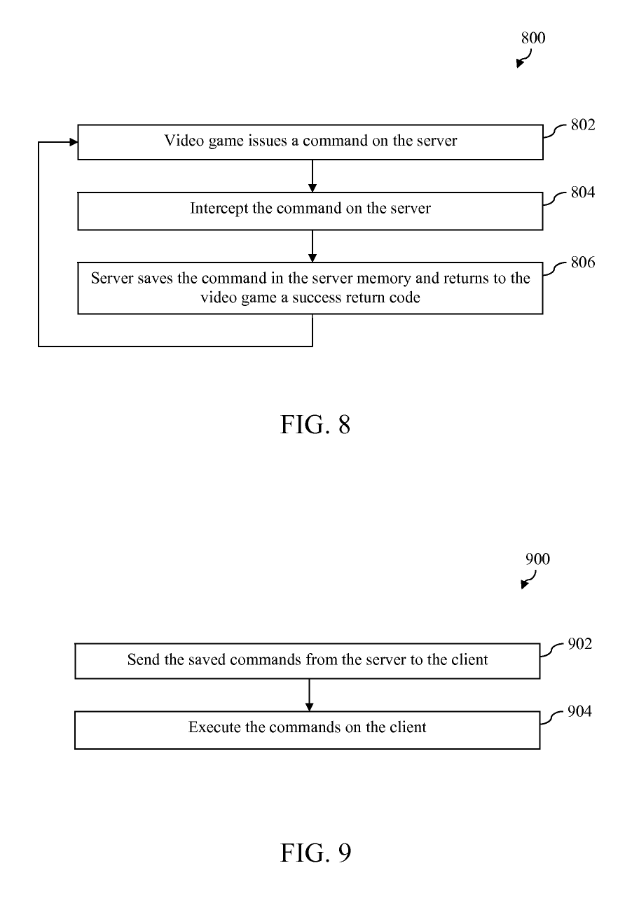

FIGS. 8 and 9 depict flowcharts 800 and 900, respectively, of associated methods for emulating commands on a server in a client-server system in accordance with an embodiment of the present invention. The method of flowcharts 800 and 900 may be implemented, for example, by software components on server 202 and client 204 of system 200 as described above in reference to FIG. 2, although the methods are not limited to those embodiments. Furthermore, the methods of flowcharts 800 and 900 represent only one manner of emulating commands on a server in a client-server system and are not intended to be limiting.

As shown in FIG. 8, the method of flowchart 800 begins at step 802 in which a video game issues a command on a server. At step 804, the command issued during step 802 is intercepted. At step 806, the server saves the command intercepted during step 804 in server memory and returns to the video game a success return code corresponding to the command. The method of flowchart 900 depicts steps that may occur later on, in accordance with the configuration of the server. As shown in FIG. 9, the method of flowchart 900 begins at step 902 in which a number of commands saved on the server (e.g., via multiple executions of step 806 of flowchart 800) are sent to a client. At step 904, the commands are received by the client and executed thereon.

6. Graphics State Management of Objects on the Server

Graphics libraries provide an API for querying the render state of a GPU. Sometimes, video games use this API to determine if a GPU is in a correct state or to determine whether to change the render state to a new state. In a system that implements a remote UI such as described above, the issuance and execution of such commands may incur a round trip delay between a server (e.g., server 202) and a client (e.g., client 204) when a video game on the server calls such a command, the command is sent to the client, processed by the client, and the result is returned to the server and to the video game.

In order to avoid querying the render state on the GPU of the client, an embodiment maintains and caches the render state on the server by updating the render state of objects when a command is issued by a video game that changes the render state. In this way, all queries from the video game may be answered immediately on the server without being sent to the client.

For example, a game may use a GetLight command to obtain a current light object on the rendering pipeline. A software module in accordance with an embodiment of the invention monitors all such SetLight commands and maintains the updated light so all such GetLight commands can be answered using local data on the server.

Another more complex example will now be provided:

1. A video game creates a state block object using CreateStateBlock.
2. The state block object captures the full current state of a GPU, including, for example, a current texture of stage 0.
3. The video game issues a command to set another texture to the GPU.
4. The video game issues “Apply” to the captured state block.
5. The video game queries the current texture using GetTexture.
6. The real graphic state is maintained and the texture from the state block is returned to the game.

The same mechanism will work for all render state commands.

Caching of the end device capabilities: During initialization of a video game session and sometimes during game play, the video game will query the capabilities of the client. In order to avoid synchronization for such calls, an embodiment queries the capabilities of the client during the initialization of the protocol used to establish a game session and stores the capability information on the server. Any additional capabilities query to the client will be answered from the cached data.

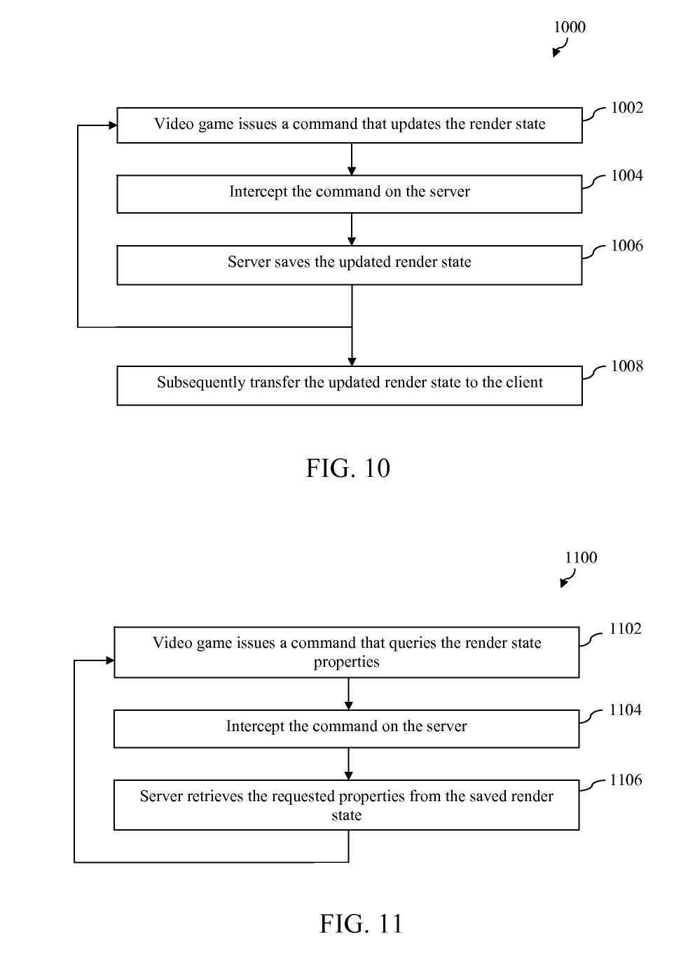

FIGS. 10 and 11 depict flowcharts 1000 and 1100, respectively, of associated method for performing graphics state management of objects on a server in accordance with an embodiment of the present invention. The method of flowcharts 1000 and 1100 may be implemented, for example, by software components on server 202 of system 200 as described above in reference to FIG. 2, although the methods are not limited to those embodiments. Furthermore, the methods of flowcharts 1000 and 1100 represent only one manner of performing graphics state management of objects on a server and are not intended to be limiting.

As shown in FIG. 10, the method of flowchart 1000 begins at step 1002 in which a video game issues a command that updates a render state of a GPU on a server. Such commands may include, for example and without limitation, SetLight, SetMaterial, or the like. At step 1004, the command issued during step 1002 is intercepted. At step 1006, the server saves the updated render state of the GPU. After step 1006, the updated render state is transferred to the client as shown at step 1008. After step 1006, the process is also repeated by returning to step 1002 when the video game issues another command that updates the render state of the GPU.

As shown in FIG. 11, the method of flowchart 1100 begins at step 1102 in which a video game issues a command that queries the render state properties of a GPU. Such commands may include, for example and without limitation, GetLight, GetMaterial, or the like. At step 1104, the command issued during step 1102 is intercepted. At step 1106, the server retrieves the requested properties from the saved render state and returns them to the video game. After step 1106, the process is repeated by returning to step 1102 when the video game issues another command that queries the render state properties of the GPU.

7. Caching of Graphics Objects on the Client

Often, when a video game initializes a new scene, it will copy a large amount of data to a GPU (e.g., textures, index buffers, and so on). During this initialization process, the video game may display a progress bar indicating the current status of the loading. This phase can take significant time even during native execution of the video game on a computing device.

In accordance with an embodiment, in order to avoid having to transfer all this data from a server (e.g., server 202) to a client (e.g., client 204) during each game session, a caching mechanism is implemented on the client side.

For example, in accordance with one embodiment, each data object is assigned a unique identifier (which may be generated, for example, by applying an MD5 algorithm to selected parts of the object). This identifier is sent to the client to determine if the object is already cached thereon. Alternatively, during initialization of a game session, the client may send a map of all the objects stored in its cache to the server so that the server can determine in advance which objects are cached and which objects must be sent. When sending a new object to the client, the server may add it to the mapping as it will now be cached by the client. In a case in which the object is not cached, the object is sent to the client. When delivered, the client stores the object in its local persistent storage and also uses it with the relevant graphic command. In a case in which the object is cached, the client restores it from the local persistent storage and uses it with the relevant graphic command

It is possible that an implementation of this “checking” protocol may slow down the initialization phase of a game session since the first time it is performed it may be necessary to send two buffers to the client, one with the object IDs and another one with the data itself when it is not cached. However, it is anticipated that the gaming experience will not suffer since this is done in the initialization phase only and not during the game session where each millisecond is important.

8. Removing Small Insignificant Frequently Updating Particles

Some video games render small particles that are updated frequently such as snow or rain. Usually, these particles do not influence the game logic but are created by the designers as an atmospheric effect only. On the other hand, these particles are stored in a vertex buffer that is updated in each frame. Since snow and rain contain a large number of particles, this can load the network with additional traffic.

In accordance with an embodiment, such particles are identified using their vertex buffers, textures, and the rest of the attributes of the graphic state by analyzing the video game in a pre-production environment. The identification is stored in a metadata persistent storage along with a game package on a server (e.g., server 202). When the game is executed on the server, the same identification mechanism is used to identify the particles buffers and each such identified particles buffer is not sent to the client (e.g., client 204) and is thus not rendered on the client at all. By doing this, a significant amount of traffic can be removed from the network.

Using this method it is possible to remove all such objects or filter the number of objects—for example, sending only 50% of a total number of rain drops. Alternatively, it is possible to send a reduced number of objects, for example 10% of a total number of rain drops, and then on the client generate the additional 90% of the raindrops in the estimated position and in accordance with the attributes of the 10% of drops that are actually sent.

9. Removing Small Objects from the Scene

In order to further reduce the consumed bandwidth between a server (e.g., server 202) and client (e.g., client 204), an embodiment removes objects that will be projected to an insignificant part of the screen and will not be, practically, visible to a user. For example, when a 3D object is small and far away, it will be rendered to a few pixels on the screen.

This may be achieved on the server side by un-projecting a vertex buffer of a 3D object onto a surface that represents the screen. The same world, view and projection used by a video game are used, un-projecting the vertex buffer to the same logical viewport (for example, with respect to Direct3D®, using D3DXVec3Unproject). As a result, a new vertex buffer is obtained with the same number of vertices that is unprojected to the viewport of the video game. Next, the maximum difference in the x-axis and y-axis is analyzed to determine the size of the unprojected object. In cases in which an object will not be displayed because it is not larger than a predetermined number of pixels, all the commands that are related to such an object are omitted from the 3D command stream.

D. Converting Vertex Changes to Matrices

Much of the functionality of a 3D video game is implemented by using vertex buffers. Consequently when a system such as that shown in FIG. 2 is used to play a 3D video game, most of the data that must be transferred from server 202 to client 204 will consist of vertex buffers.

In order to reduce the amount network bandwidth required to deliver such data, it would be advantageous to compress the buffers as much as possible based on the fact that most likely there is some logic to the way a vertex is manipulated by the game code. The explanation below describes a method for achieving a very strong logical compression of vertex buffers that can significantly compress the data and as a result significantly reduce the bandwidth required for transmitting a stream of 3D commands from a server to a client. The general idea involves extracting matrices representing changes to vertices memory, be it vertex buffers, system memory, or stack memory, and sending the matrix from the server to the client instead of all the data of the changed vertices.

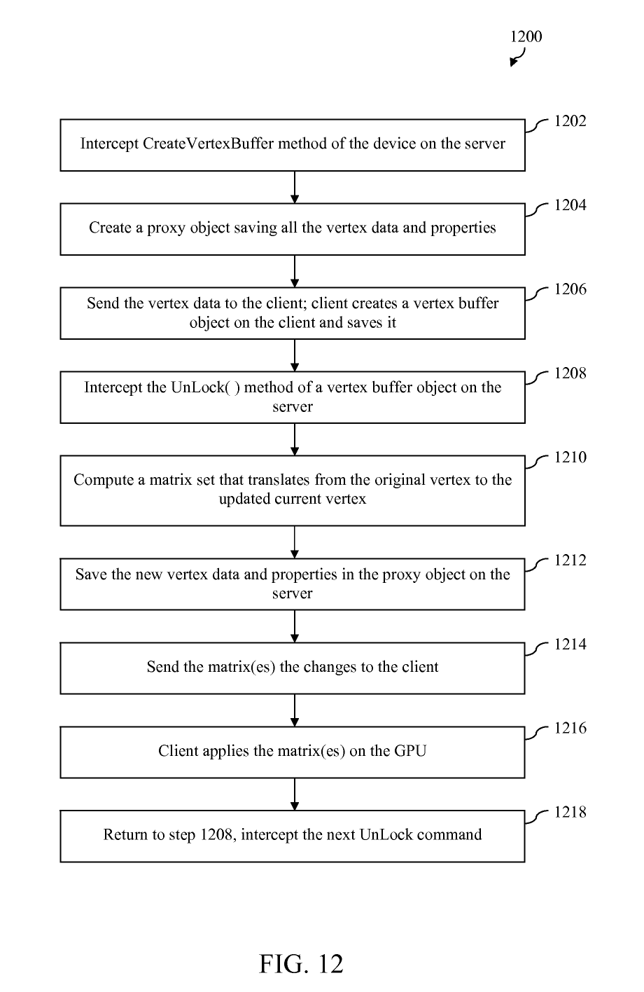

FIG. 12 depicts a flowchart 1200 of one method for converting vertex changes to matrices and transferring such matrices to a client in accordance with an embodiment of the present invention. The method of flowchart 1200 may be implemented, for example, by software components on server 202 and client 204 of system 200 as described above in reference to FIG. 2, although the method is not limited to those embodiments. Furthermore, the method of flowchart 1200 represents only one manner of converting vertex changes to matrices and transferring such matrices to a client and is not intended to be limiting.

As shown in FIG. 12, the method of flowchart 1200 begins at step 1202, in which a CreateVertex Buffer method of a device is intercepted on the server. At step 1204, a proxy object is created on the server that saves all the vertex data and properties. At step 1206, the vertex data is sent to the client and the client creates a vertex buffer object on the client based on the vertex data and saves the vertex buffer object. At step 1208, an UnLock( ) method of a vertex buffer object on the server is intercepted. At step 1210, a matrix set that translates from the original vertex to the updated current vertex is computed. At step 1212, the new vertex data and properties are saved in the proxy object on the server. At step 1214, the matrix(es) of the changes are sent to the client. At step 1216, the client applies the matrix(es) on a GPU of the client. At step 1218, control returns to step 1208 in which the next UnLock command is intercepted.

Two methods may be used to obtain the matrices that represent the changes of a vertex memory area that was changed and must be updated on the client: (1) obtaining the matrix from a utility functions that the games' graphic engine calls (for example: D3DX* functions); or (2) applying a mathematical analysis to the numeric values of the vertices properties and extracting the matrices that represent the changes. Each of these methods will be described below.

1. Obtain Matrices from Utility Functions

Video games and games graphic engines commonly use an internal set of utility functions to perform various 3D tasks such as vertex transformations. This set of commands uses a CPU for calculating the transforms.

The matrices may be obtained from the utility functions using the following steps:

1. Using interception techniques, intercept all the utility functions, which are for example:

a. D3DXVec2TransformArray

b. D3DXVec2TransformCoordArray

c. D3DXVec2TransformNormalArray

d. D3DXVec3TransformArray

e. D3DXVec3TransformCoordArray

f. D3DXVec3TransformNormalArray

g. D3DXVec3ProjectArray

h. D3DXVec3UnprojectAnay

i. D3DXVec4TransformArray

in all of the dll versions from d3dx9_{—}24.dll to d3dx9_{—}42.dll and as more become available.

The following is an example usage of a function:

// Transform Array (x, y, z, 1) by matrix, project result back into w=1.

### D3DXVECTOR3* WINAPI D3DXVec3TransformCoordArray

(D3DXVECTOR3 *pOut, UINT OutStride, CONST D3DXVECTOR3 *pV, UINT

### VStride, CONST D3DXMATRIX *pM, UINT n);

pV is a pointer to the input vertex array.

pM is a pointer to the matrix by which to transform the vertices pointed by pV.

pOut is a pointer to the result (vertices array) of the matrix transformation of pV by pM.

By intercepting this function, the matrix pointed to by pM can be obtained without additional CPU analysis. This matrix can be sent to the client instead of the full vertex array and the client can perform the transformation locally and obtain the same result. As a result, a much smaller buffer is sent from the server to the client and the resulted bandwidth consumption is much smaller.

2. If the game is using a different graphic engine, intercept all the common graphics engines libraries vertex transformation functions and achieve the same results.

3. The compressed matrix (as described above in Section III.C.2) is saved and sent to the client only for vertices that are relevant to the next draw command (as discussed above in section III.C.1).

2. Mathematical Calculation of Matrices

When a video game (or the game's engine) is using its own custom vertex transformation functions, a more general method for extracting the transformation matrices may be used. The changes in the vertices properties are analyzed and the matrices that represent the changes are calculated in the following way:

1. Intercept all the drawing commands and all the commands that change the content of the vertices that represents the 3D objects of the scene.
2. In each frame, maintain a database of all the vertex memory regions that were used for drawing.
3. The analysis of the vertex buffers is done only for the changed regions that are in a size that justifies the calculations in terms of bandwidth (for example, a change in a single vertex does not justify sending a matrix).
4. For each region that was changed and need to be sent to the client, start with the analysis of the first 4 vertices and, if possible, extract a matrix that represents the change. The full description of how to extract a transformation matrix from a set of vertices is explained below in section III.D.3. In a case in which there is no transformation matrix for the vertices, another approach is taken (see section Error! Reference source not found.III.C.1).
5. The section within the region that the extracted matrix is valid for is determined, and the matrix itself is sent to the client with the memory section definition. The matrix is compressed using matrix-compression as described in section III.C.2.
6. The client applies the transformation matrix to the corresponding vertices on the vertex buffer.
7. Steps 4-6 are repeated on the rest of the sections in the same region.

3. Extracting a Transformation Matrix from a Set of Vertices

All of the calculations are done in 4D, as these are 4 component vectors. The W component is ignored.

One can transform any point (x, y, z) into another point (x′, y′, z′) using a 4 by 4 matrix:

$$[ {x}^{′} , {y}^{′} , {z}^{′} , 1 ] = [ x , y , z , 1 ] [ \begin{matrix}{M}_{11} & {M}_{12} & {M}_{13} & {M}_{14} \\ {M}_{21} & {M}_{22} & {M}_{23} & {M}_{24} \\ {M}_{31} & {M}_{32} & {M}_{33} & {M}_{34} \\ {M}_{41} & {M}_{42} & {M}_{43} & {M}_{44}\end{matrix} ]$$

The following operations are performed on (x, y, z) and the matrix to produce the point (x′, y′, z′):

x′=(x×M₁₁)+(y×M₂₁)+(z×M₃₁)+(1×M₄₁)

y′=(x×M₁₂)+(y×M₂₂)+(z×M₃₂)+(1×M₄₂)

z′=(x×M₁₃)+(y×M₂₃)+(z×M₃₃)+(1×M₄₃)

Matrix extraction can be performed in the several ways. In one embodiment, the source and target positions of the vertices are used and 16 equations with 16 variables are obtained. Fortunately, these can be divided to 4 independent sets of 4 equations with 4 variables each, which can be solved with Cramer's rule as will now be described.

Cramer's Rule. Cramer's rule is an explicit formula for the solution of a system of linear equations, with each variable given by a quotient of two determinants. For example, the solution to the system

x+3y−2z=5

3x+5y+6z=7

2x+4y+3z=8

is given by

$$x = \frac{\vert \begin{matrix}5 & 3 & - 2 \\ 7 & 5 & 6 \\ 8 & 4 & 3\end{matrix} \vert}{\vert \begin{matrix}1 & 3 & - 2 \\ 3 & 5 & 6 \\ 2 & 4 & 3\end{matrix} \vert} y = \frac{\vert \begin{matrix}1 & 5 & - 2 \\ 3 & 7 & 6 \\ 2 & 8 & 3\end{matrix} \vert}{\vert \begin{matrix}1 & 3 & - 2 \\ 3 & 5 & 6 \\ 2 & 4 & 3\end{matrix} \vert} z = \frac{\vert \begin{matrix}1 & 3 & 5 \\ 3 & 5 & 7 \\ 2 & 4 & 8\end{matrix} \vert}{\vert \begin{matrix}1 & 3 & - 2 \\ 3 & 5 & 6 \\ 2 & 4 & 3\end{matrix} \vert}$$

For each variable, the denominator is the determinant of the matrix of coefficients, while the numerator is the determinant of a matrix in which one column has been replaced by the vector of constant terms.

Though Cramer's rule is important theoretically, it has little practical value for large matrices, since the computation of large determinants is somewhat cumbersome. (Indeed, large determinants are most easily computed using row reduction.) Furthermore, Cramer's rule has very poor numerical properties, making it unsuitable for solving even small systems reliably, unless the operations are performed in rational arithmetic with unbounded precision.

In this way, all 16 members of the matrix are calculated.

E. Mapping HID Events to Keyboard and Mouse Events

An embodiment of the present invention maps human input device (HID) events triggered by a client (e.g., client 204) to keyboard and mouse events at a server (e.g., server 202). The HID on the client is identified and interception is used. Then HID events are mapped to keyboard and mouse events.

For example, assume a video game utilizes the ‘w’ key to move forward, the ‘a’ key to move left, the ‘s’ key to move back and the ‘d’ key to move right. Since those keys do not exist on a gamepad it may be necessary to define which controls of the gamepad are allocated to the different movements and when the gamepad issues those commands they are translated to the movement commands and injected into the game process. The mapping definition may take place on the server but may also be executed on the client.

F. Audio Interception

In accordance with certain embodiments, audio interception is used to intercept the audio of a video game and prevent it from being played on the server. The intercepted audio is mixed, encoded and streamed to the client for decoding and playback. Several methods for performing audio interception may be used including but not limited to using a virtual audio device, performing interception of DirectSound calls, and performing interception of IOControl requests.

G. Fixed DirectX Pipeline to Programmable OpenGL Pipeline Conversion

Most embedded clients support only OpenGL® ES. All Linux® clients capable of 3D rendering support OpenGL®. OpenGL® ES is a subset of OpenGL®, therefore any client that supports OpenGL® 2.0 (or lower but with shaders extension) will be able to run OpenGL® ES commands. In accordance with an embodiment of the present invention, DirectX® (fixed pipeline) commands are translated to OpenGL® ES (programmable pipeline) commands.

A particular example implementation will now be described. On each rendering command (one of the 4 DrawPrimitives), the graphics state is compiled into a GL Shader Language (GLSL) ES shader. The rendering command itself is translated into an OpenGL rendering command.

Each state has a corresponding shader. These are cached on the server and are only transferred to the client once. Then the client compiles and uses those shaders to render the objects on the display.

An example of compiling vertex state into a vertex shader code will now be provided. In accordance with this example, the DirectX® vertex state is as follows:

(1) only vertex positions and texture coordinates are present in the vertex buffer; (2) a primitive is drawn using processed vertices (D3DFVF_XYZRHW vertex format); and
(3) lighting is disabled. The GLSL ES vertex shader code is:

```
attribute vec4 vPosition;
uniform vec4 uViewportInverseData;
attribute vec2 vTexCoord0;
varying vec4 fTexCoord0;
varying vec4 fColor;
varying vec4 fSecondaryColor;
void main( )
{
  gl_Position = vec4(−1. + vPosition.x * uViewportInverseData.x, 1. +
vPosition.y * uViewportInverseData.y, vPosition.z, 1.) / vPosition.w;
  fTexCoord0 = vec4(vTexCoord0, vec2(0.));
  //default initializers
  fColor = vec4(1.);
  fSecondaryColor = vec4(0.);
}
```

A further example involving pixel state will now be provided. In accordance with this example, the DirectX® pixel state is as follows: (1) one texture stage is used; (2) color and alpha for the first stage are copied from the first source (D3DTOP_SELECTARG1); and (3) first source of first stage is a texture (D3DTA_TEXTURE). The GLSL ES fragment shader is:

```
varying vec4 fColor;
varying vec4 fSecondaryColor;
varying vec4 fTexCoord0;
uniform sampler2D uSampler0;
void main( )
{
  vec4 currentColor = fColor;
  vec4 textureValue[8];
  textureValue[0] = texture2D(uSampler0, fTexCoord0.xy);
  //stage 0
  currentColor.rgb = textureValue[0].rgb;
  currentColor.a = textureValue[0].a;
  gl_FragColor = currentColor;
}
```

G. Adjusting 3D Resources for Better Video Encoding

In another example implementation, the video game is executed on the server (e.g., server 202), rendered on the server, and the frame image is captured on the server, and encoded to a video stream that is transferred to the client (e.g., client 204) over the network. The client has a video player component that plays the video and displays the video game UI on the client.

In accordance with this implementation, it is necessary to match the buffer used by the server to render the frame to the client resolution so that performance is optimized in the video encoding and the server does not have to encode a frame that has higher resolution than what is supported by the client.

In order to reduce the CPU utilization on the server side for video encoding, the resolution of the back buffer of the game scene is reduced to the resolution of the target client. This way, the video encoder will encode a frame that is adjusted to the screen of the client.

When the video game creates a surface that is to be adjusted, the resolution that was requested by the video game is changed to a resolution that fits the video encoder requirements. The possible adjusted surfaces are render targets and depth stencil surfaces. In one embodiment, in order to maintain the ratio of all the DirectX® surfaces, the resolution of all the surfaces is changed with the same scale factor.

For example, initialization and usage of a DirectX® back buffer may be achieved as follows:

1. A video game issues a CreateDevice request with a requested resolution of back buffer.
2. A proxy intercepts the call and changes the requested resolution input to a resolution of the client screen.
3. The video game gets a device object with alternate resolution.
4. All the objects that are being rendered into this back buffer using the device object are automatically scaled.
5. On each creation of render target surface, depth stencil surface or textures with render target usage are scaled by the same factor that was used in step 2.
6. Some other commands need to be adjusted such as SetViewport and all rendering commands that use processed vertices.

H. Enabling the Use of the Server as a Home PC

In another example implementation, the server is run as a home PC and the video game graphics are sent to the client over a home network. This model is very cost-effective as compared to a model where the video game is executed on a server accessed via the Internet as it utilizes the home PC and does not require a huge investment in infrastructure by the service provider.

When the server is a home PC running a game and streaming it to another client, it would be desirable to enable other users to use this PC for other tasks such as browsing the Internet, editing documents, etc. To achieve that, the video game window must be hidden from the PC desktop and the video game must be prevented from capturing input from the server via mechanisms such as windows system wide hooks and DirectInput events.

In accordance with one embodiment, in order to hide the video game window from the PC desktop, some of the windows API that handles window visibility and input are intercepted and provided with a DirectInput proxy to prevent the game from using the server's input devices. For example, when a video game uses ShowWindow to call to a window that was created by CreateWindow, the call is blocked from being passed to the operating system. As a result, the operating system does not render the window on the desktop while the video game still “thinks” that the window is visible.

The audio of the game is not played on the local server but is intercepted using one of a variety of methods.

The controls that are captured on the client are injected directly to the game application using SendMessage or by putting the controls in the emulated DirectInput module of the game.

In another example, a system is configured with a server, a client PC and a client device. The server is accessible via the Internet and can be accessed by the user to download video games. The client PC is running software that can download a video game from the server and execute the game. The client device is connected to the client PC and can receive game graphics from the client PC using one of graphics streaming or video streaming. The client device can send a request to the client PC to download a video game and, responsive to receiving the request, the client PC will download the video game from the server. The client device can also issue a request to the client PC to start the video game and, responsive to receiving the request, the client PC will execute the video game and will send game graphics to the client device.

In another example, the system is configured as follows. A software component A is installed on the PC at home. A software component B is installed on a TV or alternative client device at home that is not capable of running the video game. Component A receives a list of available games from a server via the Internet. Component B is connected to component A to retrieve the list of available games that are compatible for playing by streaming video to the device B. Responsive to a user selecting to download a game on device B, component B notifies component A and as a result component A starts downloading the game from the Internet. After the game is downloaded, the user of device B can initiate a play command. As a result, component A will initiate an authentication process and will launch the game on device A and stream the game video to device B. Depending upon the implementation, video and/or graphics commands can be streamed. Device B captures users commands, sends them to component A and component A injects the commands into the game process.

The system can be implemented by combining the streaming of the game UI to an alternative device in the local network with the teachings of one or more of the following references: U.S. Pat. No. 7,533,370 entitled “Security Features in On-Line and Off-Line Delivery of applications,” U.S. Pat. No. 7,465,231 entitled “Systems and Methods for Delivering Content over a Network,” and U.S. Pat. No. 6,453,334 entitled “Method and Apparatus to Allow Remotely Located Computer Programs and/or Data to be Accessed on a Local Computer in a Secure, Time-Limited Manner, with Persistent Caching.”

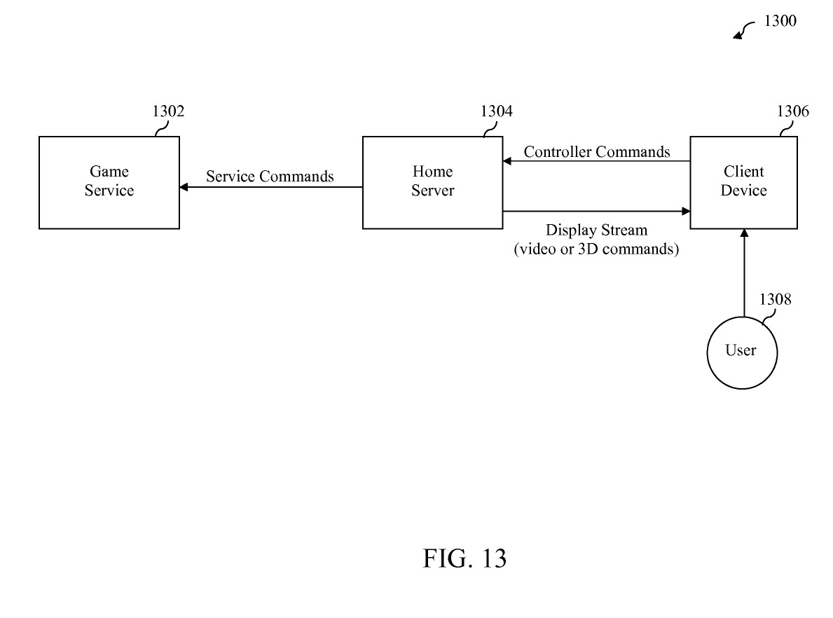

FIG. 13 is a block diagram of an example system 1300 that utilizes a home PC as a server in accordance with an embodiment of the present invention. As shown in FIG. 13, system 1300 includes an Internet-accessible game service 1302, a home server 1304 implemented on a home PC that is communicatively connected to game service 1302, and a client device 1306 (e.g., a TV, handheld device, etc.) in the home that is communicatively connected to home server 1304. A user 1308 interacts with client device 1306 to play a video game that is executed on home server 1304

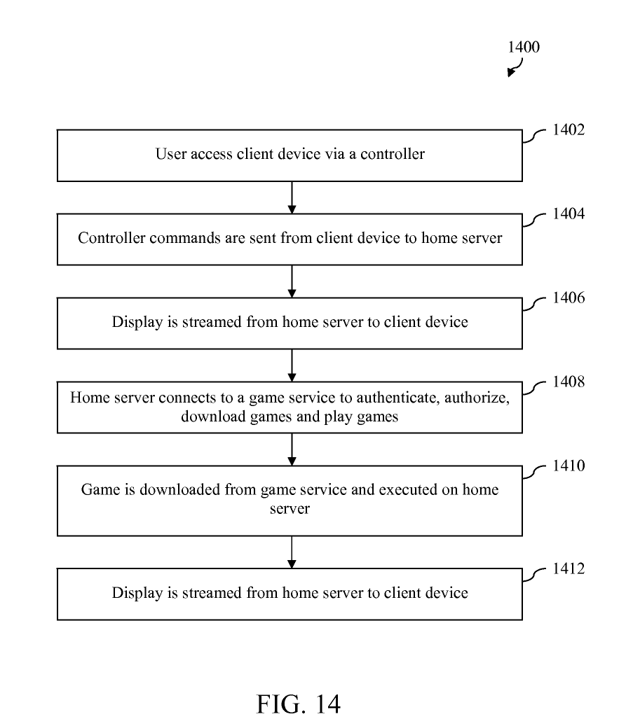

FIG. 14 depicts a flowchart 1400 of a method for operating a system, such as system 1300, which utilizes a home PC as a server in accordance with an embodiment of the present invention. The method of flowchart 1400 will now be described in reference to system 1300 of FIG. 13. However, the method is not limited to that embodiment.

As shown in FIG. 14, the method of flowchart 1400 begins at step 1402 in which user 1308 accesses client device 1306 using a controller. At step 1404, controller commands generated on client device 1306 responsive to such user interaction are sent from client device 1306 to home server 1304. At step 1406, display data (either in the form of video or 3D commands) is streamed from home server 1304 to client device 1306. At step 1408, home server 1304 connects to game service 1302 to authenticate, authorize, download video games and play video games. At step 1410, a video game is downloaded to home server 1304 from game service 1302 and executed on home server 1410. At step 1412, display is streamed from home server 1304 to client device 1412.

I. Rendering the Cursor on the Client Side

Many video games use a cursor to indicate a position on a screen that will respond to user input for mouse clicks, text input, or other forms of user input. However, sometimes the cursor may not be visible on the screen such as when a video game is rendering a cut scene or when a current mode of interaction with the scene does not require pointing to a specific point (e.g. viewing mode in 3^{rd} person shooters). The shape of the cursor might change according to its position and the context of the video game.

In accordance with an embodiment, in order to achieve a better user experience, a cursor is rendered by code executing on the client instead of by rendering the cursor into the 3D scene on the server and streaming the frame with the positioned cursor to the client. Typically, video games use one of two methods to display a cursor in the game: (1) using the system cursor of Windows; or (2) rendering a shape at the position of the cursor while hiding the system cursor. A different approach to rendering the cursor on the client may be used depending on the method used by a particular video game. Each approach will now be described.

System Cursor. When the user is moving the mouse or other pointing control, the client operating system handles the request and displays the cursor on the client. The client sends the cursor position to the server, which injects the cursor position into the game process.

When the video game uses the system cursor, the cursor API from the operating system on the server is intercepted and messages are sent to the client to hide/show the cursor and, when needed, change its shape. The client uses those commands to create, show, hide and change the cursor shape on the client. The position of the cursor is streamed back to the server and injected into the game executable, allowing the game to react to the change in cursor position. In this way, the user will perceive a fluent movement of the cursor while the reaction of the game will be visible on the next frame.

An example will now be provided. Typically, when the cursor is over an interesting area in the game, the game may want to change the cursor. Since the cursor is now rendered on the client side, it is necessary to send the command to the client. This is achieved as follows:

1. A video game sets a cursor using the SetCursor Windows API.
2. This call from the video game is blocked so that the cursor rendered over the game is not rendered.
3. The bitmap of the cursor is copied.
4. A command to set a cursor is encoded.
5. The command and the cursor bitmap are sent to the client.
6. The client issues the command to set a new cursor shape using the local operating system API and the mouse cursor is now rendered using the new bitmap.

Rendered Cursor. The situation is a little bit more complicated when the video game uses a shape as a cursor. The video game can use the DirectX® API to setup a bitmap as a cursor (SetCursorProperties), set its position (SetCursorPosition) and hide/show the cursor (ShowCursor). In this case, the same method as that used for a system cursor can be used to send the actions to the client. However, games can hide the system cursor and manage the cursor completely in the game logic using a special texture as a cursor image. In this case, during a pre-production phase, the set of textures that represents the cursor images are identified and any changes to these textures are monitored. Any draw command to those textures is removed from the scene, allowing the client to render it on the end-device. When the video game changes the texture of the object the represents the cursor, show/hide commands are sent to the client with the texture properties so the client will be able to render the new cursor on the end-device.

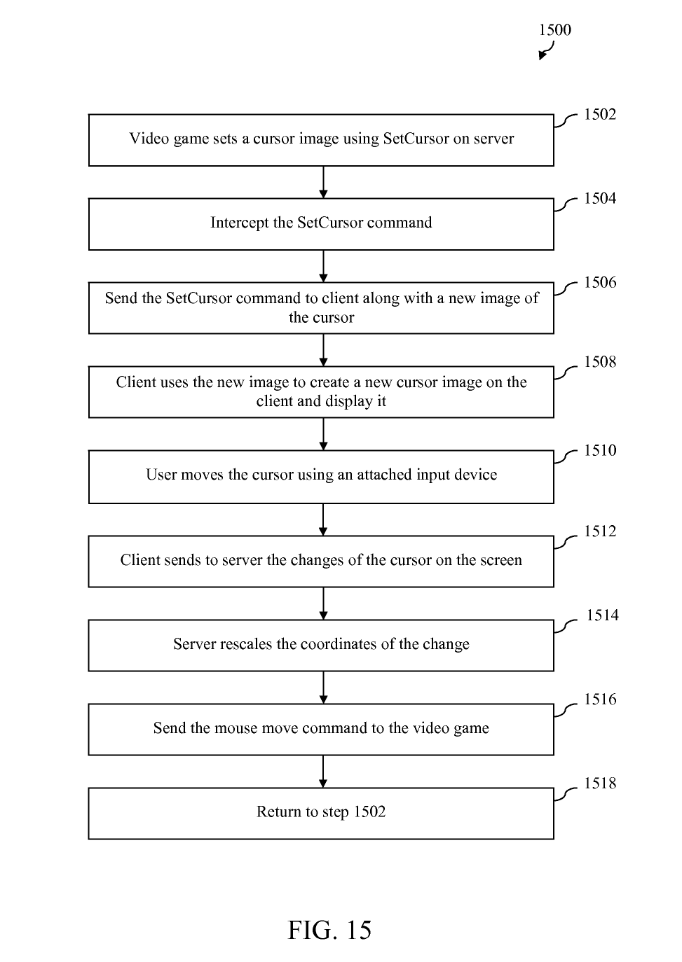

FIG. 15 depicts a flowchart 1500 of a first method for rendering a cursor on a client side of a client-server system in accordance with an embodiment of the present invention. The method of flowchart 1500 may be implemented, for example, by software components on server 202 and client 204 of system 200 as described above in reference to FIG. 2, although the method is not limited to those embodiments. Furthermore, the method of flowchart 1500 represents only one manner of rendering a cursor on a client side of a client-server system and is not intended to be limiting.

As shown in FIG. 15, the method of flowchart 1500 begins at step 1502, in which a video game executing on a server sets a cursor image using SetCursor. At step 1504, the SetCursor command is intercepted on the server. At step 1506, the SetCursor command is sent to the client along with a new image of the cursor. At step 1508, the client uses the new image to create a new cursor image on the client and display it. At step 1510, a user of the client moves the cursor using an input device attached to the client. At step 1512, the client sends to the server any resultant changes to cursor on the screen. At step 1514, the server rescales the coordinates of the change. At step 1516, the mouse move command is sent to the video game. At step 1518, control returns to step 1502 and the video game again sets the cursor image using SetCursor.

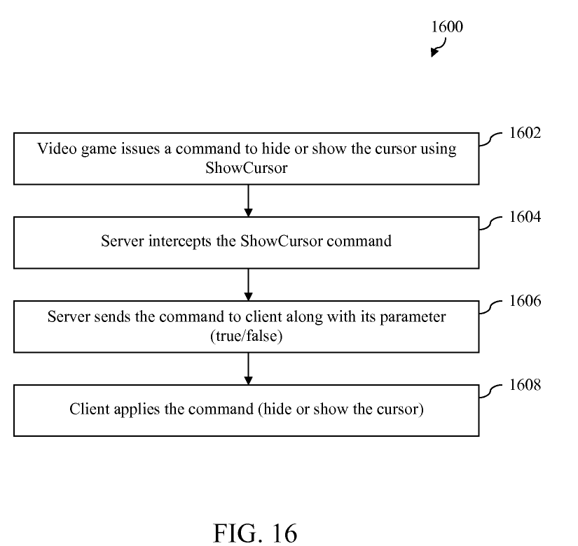

FIG. 16 depicts a flowchart 1600 of a second method for rendering a cursor on a client side of a client-server system in accordance with an embodiment of the present invention. The method of flowchart 1600 may be implemented, for example, by software components on server 202 and client 204 of system 200 as described above in reference to FIG. 2, although the method is not limited to those embodiments. Furthermore, the method of flowchart 1600 represents only one manner of rendering a cursor on a client side of a client-server system and is not intended to be limiting.

As shown in FIG. 16, the method of flowchart 1600 begins at step 1602, in which a video game executing on a server issues a command to hide or show the cursor using ShowCursor. At step 1604, the ShowCursor command is intercepted on the server. At step 1606, the server sends the ShowCursor command is to the client along with its parameter (true/false). At step 1608, the client applies the command by hiding or showing the cursor.

J. Streaming from a Server to a Web Browser

It is anticipated that next-generation Web browsers will be released with 3D capabilities. Accordingly, the following section describes rendering commands in the browser using those capabilities.

WebGL is an example implementation of enabling OpenGL® capabilities in browsers through JavaScript functions. In accordance with an embodiment, the system includes a client that executes a browser with 3D rendering capabilities such as WebGL and a server. The client connects to the server and requests execution of a video game. In response to the request, the video game process is launched on the server and display commands from the video game are intercepted on the server and sent to the client through HTTP or some other protocol supported by the browser. In one example implementation, the browser on the client runs a JavaScript that connects to the server and requests the commands that should be executed. In response to the request, the commands are returned to the client and decoded in accordance with methods described elsewhere herein. In order to execute the graphics commands, the JavaScript calls the WebGL API in order to call the OpenGL function call.

The advantages of using a Web browser include that it does not require the downloading and installation of software on the client and this makes it much easier for users to access the content.

### IV. Example Method for Transferring Graphics Commands

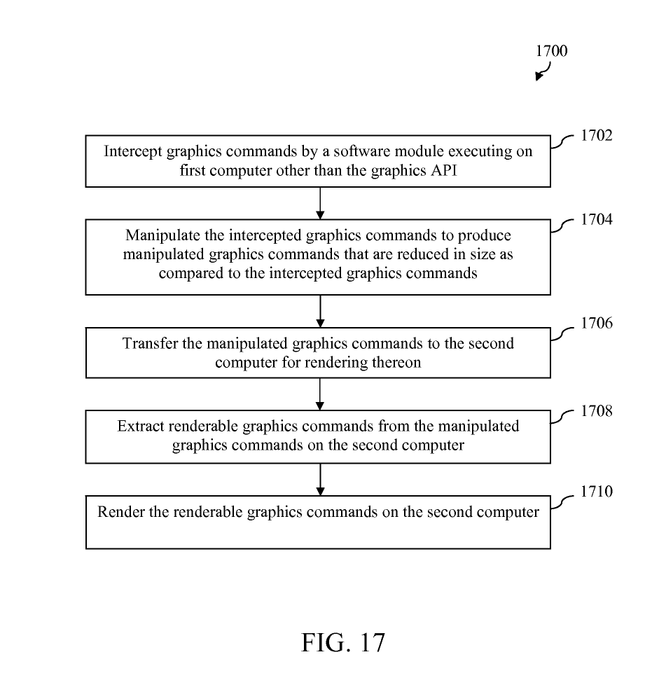

FIG. 17 depicts a flowchart of a method for transferring graphics commands generated by a software application, such as a video game application, executing on a first computer to a second computer for rendering thereon in accordance with an embodiment. The graphics commands are directed to a graphics application programming interface (API). In one embodiment, the first computer comprises server 102 of system 100 and the second computer comprises any of remote UIs 1061-106N of system 100. In another embodiment, the first computer comprises server 202 of system 200 and the second computer comprises client 204 of system 200. However, these examples are not intended to be limiting and the method of flowchart 1700 may be performed by other systems or components.

As shown in FIG. 17, the method of flowchart 1700 begins at step 1702 in which the graphics commands are intercepted by a software module executing on the first computer other than the graphics API. At step 1704, the intercepted graphics commands are manipulated to produce manipulated graphics commands that are reduced in size as compared to the intercepted graphics commands. At step 1706, the manipulated graphics commands are transferred to the second computer for rendering thereon. At step 1708, renderable graphics commands are extracted from the manipulated graphics commands on the second computer and at step 1710, the renderable graphics commands are rendered on the second computer.

In one embodiment, manipulating the intercepted graphics commands in step 1704 comprises compressing vertex buffer data associated with at least one intercepted graphics command. The compression of vertex buffer data was described above in Section III.C.1.

In another embodiment, manipulating the intercepted graphics commands in step 1704 comprises compressing at least one matrix associated with at least one intercepted graphics command. The compression of matrixes was described above in Section III.C.2.

In yet another embodiment, manipulating the intercepted graphics commands in step 1704 comprises identifying and compressing repeated sequences of intercepted graphics commands. The identification and compression of graphics command sequences was described above in Section III.C.3.

In a further embodiment, manipulating the intercepted graphics commands in step 1704 comprises compressing at least one texture object associated with at least one graphics command. The compression of text objects was described above in Section III.C.4.

In a still further embodiment, manipulating the intercepted graphics commands in step 1704 comprises identifying and removing data associated with one or more of the intercepted graphics commands that is used to represent particles. The identification and removal of data associated with graphics commands used to represent particles was described above in Section III.C.8.

In another embodiment, manipulating the intercepted graphics commands in step 1704 comprises identifying and removing intercepted graphics commands used to render objects that are less than a predetermined size. The identification and removal of intercepted graphics commands used to render objects that are less than a predetermined size was described above in Section III.C.9.

In yet another embodiment, manipulating the intercepted graphics commands in step 1704 comprises replacing vertex changes associated with at least one intercepted graphics command with a matrix representative thereof. The replacement of vertex changes with a matrix representative thereof was described above in Section III.D.

In a further embodiment, the method of flowchart 1700 further includes emulating rendering of one of the intercepted graphics command on the first computer by generating a result corresponding thereto and returning the result to the software application. The emulated rendering of an intercepted graphics command in this manner was described above in Section III.C.5.

In a still further embodiment, the method of flowchart 1700 further includes the steps of caching one or more graphics objects associated with one or more of the intercepted graphics commands on the second computer. Such caching of graphics objects was described above in Section III.C.7.

### V. Example Computer System Implementation

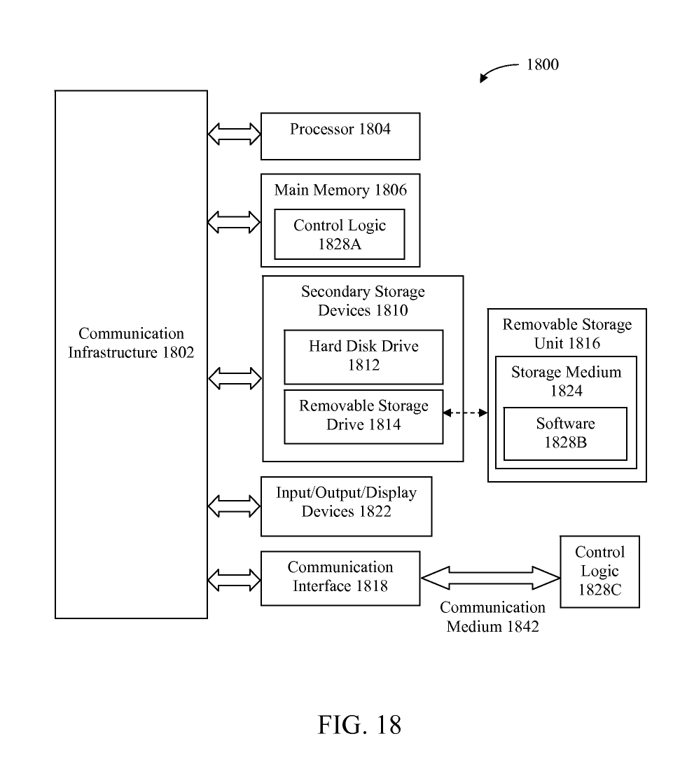

The embodiments described herein, including systems, methods/processes, and/or apparatuses, may be implemented using well known servers/computers, such as a computer 1800 shown in FIG. 18. For example, server 102 and any of remote UIs 106₁-106_{N} described above in reference to FIG. 1 may be implemented using one or more computers 1800. Likewise, each of server 202 and client 204 described above in reference to FIG. 2 may be implemented using one or more computers 1800. Furthermore any of the method steps described in reference to the flowcharts of FIGS. 3-12 and 14-17 may be implemented by software modules executed on computer 1800.

Computer 1800 can be any commercially available and well known computer capable of performing the functions described herein, such as computers available from International Business Machines, Apple, Sun, HP, Dell, Cray, etc. Computer 1800 may be any type of computer, including a desktop computer, a server, etc.

Computer 1800 includes one or more processors (also called central processing units, or CPUs), such as a processor 1804. Processor 1804 is connected to a communication infrastructure 1802, such as a communication bus. In some embodiments, processor 1804 can simultaneously operate multiple computing threads.

Computer 1800 also includes a primary or main memory 1806, such as random access memory (RAM). Main memory 1806 has stored therein control logic 1828A (computer software), and data.

Computer 1800 also includes one or more secondary storage devices 1810. Secondary storage devices 1810 include, for example, a hard disk drive 1812 and/or a removable storage device or drive 1814, as well as other types of storage devices, such as memory cards and memory sticks. For instance, computer 1800 may include an industry standard interface, such a universal serial bus (USB) interface for interfacing with devices such as a memory stick. Removable storage drive 1814 represents a floppy disk drive, a magnetic tape drive, a compact disk drive, an optical storage device, tape backup, etc.

Removable storage drive 1814 interacts with a removable storage unit 1816. Removable storage unit 1816 includes a computer useable or readable storage medium 1824 having stored therein computer software 1828B (control logic) and/or data. Removable storage unit 1816 represents a floppy disk, magnetic tape, compact disk, DVD, optical storage disk, or any other computer data storage device. Removable storage drive 1814 reads from and/or writes to removable storage unit 1816 in a well known manner.

Computer 1800 also includes input/output/display devices 1822, such as monitors, keyboards, pointing devices, etc.

Computer 1800 further includes a communication or network interface 1818. Communication interface 1818 enables computer 1800 to communicate with remote devices. For example, communication interface 1818 allows computer 1800 to communicate over communication networks or mediums 1842 (representing a form of a computer useable or readable medium), such as LANs, WANs, the Internet, etc. Network interface 1818 may interface with remote sites or networks via wired or wireless connections.

Control logic 1828C may be transmitted to and from computer 1800 via communication medium 1842.

Any apparatus or manufacture comprising a computer useable or readable medium having control logic (software) stored therein is referred to herein as a computer program product or program storage device. This includes, but is not limited to, computer 1800, main memory 1806, secondary storage devices 1810, and removable storage unit 1816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for performing, for example, any of the steps described above in the flowcharts of FIGS. 3-12 and 14-17 and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### VI. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for transferring graphics commands generated by a software application executing on a first computer to a second computer for rendering thereon, the graphics commands being directed to a graphics application programming interface (API), the method comprising:
intercepting the graphics commands by a software module executing on the first computer other than the graphics API;
manipulating the intercepted graphics commands to produce manipulated graphics commands that are reduced in size as compared to the intercepted graphics commands;
transferring the manipulated graphics commands to the second computer for rendering thereon.

2. The method of claim 1, further comprising:
extracting renderable graphics commands from the manipulated graphics commands on the second computer; and
rendering the renderable graphics commands on the second computer.

3. The method of claim 1, wherein manipulating the intercepted graphics commands comprises compressing vertex buffer data associated with at least one intercepted graphics command.

4. The method of claim 1, wherein manipulating the intercepted graphics commands comprises compressing at least one matrix associated with at least one intercepted graphics command.

5. The method of claim 1, wherein manipulating the intercepted graphics commands comprises identifying and compressing repeated sequences of intercepted graphics commands.

6. The method of claim 1, wherein manipulating the intercepted graphics commands comprises compressing at least one texture object associated with at least one graphics command.

7. The method of claim 1, wherein manipulating the intercepted graphics commands comprises identifying and removing data associated with one or more of the intercepted graphics commands that is used to represent particles.

8. The method of claim 1, wherein manipulating the intercepted graphics commands comprises identifying and removing intercepted graphics commands used to render objects that are less than a predetermined size.

9. The method of claim 1, wherein manipulating the intercepted graphics commands comprises replacing vertex changes associated with at least one intercepted graphics command with a matrix representative thereof.

10. The method of claim 1, further comprising:
emulating rendering of one of the intercepted graphics command on the first computer by generating a result corresponding thereto and returning the result to the software application.

11. The method of claim 1, further comprising:
caching one or more graphics objects associated with one or more of the intercepted graphics commands on the second computer.

12. A computer program product comprising a computer-readable storage medium having computer program logic recorded thereon for enabling a processing unit to transfer graphics commands generated by a software application executing on a first computer to a second computer for rendering thereon, the graphics commands being directed to a graphics application programming interface (API), the computer program logic comprising:
first means for enabling the processing unit to intercept the graphics commands, the first means comprising a software module other than the graphics API;
second means for enabling the processing unit to manipulate the intercepted graphics commands to produce manipulated graphics commands that are reduced in size as compared to the intercepted graphics commands; and
third means for enabling the processing unit to transfer the manipulated graphics commands to the second computer for rendering thereon.

13. The computer program product of claim 12, wherein the second means comprises means for enabling the processing unit to compress vertex buffer data associated with at least one intercepted graphics command.

14. The computer program product of claim 12, wherein the second means comprises means for enabling the processing unit to compress at least one matrix associated with at least one intercepted graphics command.

15. The computer program product of claim 12, wherein the second means comprises means for enabling the processing unit to identify and compress repeated sequences of intercepted graphics commands.

16. The computer program product of claim 12, wherein the second means comprises means for enabling the processing unit to compress at least one texture object associated with at least one graphics command.

17. The computer program product of claim 12, wherein the second means comprises means for enabling the processing unit to identify and remove data associated with one or more of the intercepted graphics commands that is used to represent particles.

18. The computer program product of claim 12, wherein the second means comprises means for enabling the processing unit to identify and remove intercepted graphics commands used to render objects that are less than a predetermined size.

19. The computer program product of claim 12, wherein the second means comprises means for enabling the processing unit to replace vertex changes associated with at least one intercepted graphics command with a matrix representative thereof.

20. A system, comprising:
a first processor-based system configured to execute a first software module that intercepts graphics commands generated by a software application also executing on the first processor-based computer system and directed to a graphics application programming interface (API), manipulates the intercepted graphics commands to produce manipulated graphics commands that are reduced in size as compared to the intercepted graphics commands, and transfers the manipulated graphics commands over a network; and
a second processor-based system configured to execute a software module that receives the manipulated graphics commands over the network, extracts renderable graphics commands from the manipulated graphics commands, and renders the renderable graphics commands.
